(19) United States
(12) Patent Application Publication
(10) Pub. No.: US 2024/0174563 A1
(43) Pub. Date: May 30, 2024

(54) FIRE- RESISTANT OVERLAYS, FIRE-RESISTANT PANELS, AND PROCESSES FOR MAKING AND USING SAME

(71) Applicant: GP BUILDING PRODUCTS SERVICES LLC, ATLANTA, GA (US)

(72) Inventors: Richard David Jordan, Decatur, GA (US); Allison Nicole Goins, Marietta, GA (US); Ronald Laryea Mensah, McDonough, GA (US); Charles Chi Chuen Chan, Sandy Springs, GA (US)

(21) Appl. No.: 18/282,230

(22) PCT Filed: Mar. 22, 2022
(86) PCT No.: PCT/IB2022/052600

§ 371 Date: Sep. 15, 2023

Related U.S. Application Data
(60) Provisional application No. 63/164,867, filed on Mar. 23, 2021.
(60) Provisional application No. 63/321,169, filed on Mar. 18, 2022.

(51) Int. Cl. C03C 25/34; B32B 7/12; B32B 21/02; B32B 21/10; C09D 5/18; C09D 7/61; C09D 7/63; C09D 161/28

(52) U.S. Cl. CPC C03C 25/34; B32B 7/12; B32B 21/02; B32B 21/10; C09D 5/185; C09D 7/61; C09D 7/63; C09D 161/28; B32B 2250/02; B32B 2255/02; B32B 2255/26; B32B 2262/101; B32B 2307/3065; B32B 2307/7376; B32B 2607/00

(57) ABSTRACT

Fire-resistant overlays, panels, and processes for making and using same. The fire-resistant overlay can include a fiber mat that can include a plurality of fibers secured to one another. The fire-resistant overlay can include a coating disposed on at least one of a first and a second side thereof. The coating can include a blowing agent and an at least partially cured intumescent resin. When a side of the fiber mat that includes the coating disposed thereon is subjected to a modified ASTM D6413-99 test, where the test is modified by using a run time of 5 minutes instead of 12 seconds, a char can be produced. The char can have a density of about 0.05 g/cm³ to about 0.2 g/cm³, a length of about 8.8 cm to about 10.2, a height of about 1.25 cm to about 2.5 cm, and an expansion ratio of about 10 to about 17.5.

### CROSS-REFERENCE TO RELATED APPLICATION

This application claims priority to U.S. Provisional Patent Application No. 63/164,867, filed on Mar. 23, 2021, and U.S. Provisional Patent Application No. 63/321,169, filed Mar. 18, 2022, which are incorporated by reference herein.

### BACKGROUND

### Field

Embodiments described generally relate to fire-resistant overlays, fire resistant panels, and processes for making and using same. More particularly, such embodiments relate to fire-resistant overlays that include a fiber mat and a coating disposed on at least one of a first side and a second side of the fiber mat that includes a blowing agent and an at least partially cured intumescent resin, fire-resistant panels that include the fire-resistant overlay disposed on a substrate, and processes for making and using same.

### Description of the Related Art

Oriented strand board, plywood, structural fiberboard, gypsum, foam board, and other types of substrates are used in the construction of buildings and other structures. These types of substrates, however, are inherently flammable, which limits the applications for which the substrates can be used in the construction of buildings and other structures.

Intumescent coatings have been applied to the surface of substrates to reduce flammability and increase the number of applications the substrates can be used. Intumescent coatings act by forming an expanded layer of non-flammable or hardly flammable material when exposed to sufficient heat that shields the substrate from oxygen and/or from overheating to prevent or at least slow the spread of flame and to prevent or at least delay reductions in mechanical properties of the substrates. The intumescent coatings that are available, while capable of reducing the flammability of the substrates, still fall short in being capable of reducing the flammability of the substrates sufficiently to satisfy certain standardized fire-resistant tests such as ASTM E2768-11(2018) and/or ASTM E119-07(2021).

There is a need, therefore, for improved fire-resistant overlays and fire-resistant panels that satisfy certain standardized fire-resistant tests, such as ASTM E2768-11(2018) and/or ASTM E119-07(2021).

### SUMMARY

Fire-resistant overlays, fire-resistant panels, and processes for making and using same are provided. In some embodiments, the fire-resistant overlay can include a fiber mat that can include a plurality of fibers secured to one another and have a first side and a second side opposed to one another. The fiber mat can have a thickness extending from a surface of the first side to a surface of the second side. The fire-resistant overlay can also include a coating disposed on at least one of the first side and the second side of the fiber mat. The coating can include a blowing agent and an at least partially cured intumescent resin. When a side of the fiber mat that includes the coating disposed thereon is subjected to a modified standard test method for flame resistance of textiles, ASTM D6413-99, where the test is modified by using a run time of 5 minutes instead of 12 seconds, a char can be produced. The char can have a density of about 0.05 g/cm³ to about 0.2 g/cm³, a length of about 8.8 cm to about 10.2 cm, a height of about 1.25 cm to about 2.5 cm, and an expansion ratio of about 10 to about 17.5.

In some embodiments, the fire-resistant panel can include a substrate, a fiber mat, and a coating. The fiber mat can include a plurality of fibers secured to one another and can have a first side and a second side opposed to one another, where the first side of the fiber mat can be secured to the substrate. The coating can be disposed on the second side of the fiber mat. The coating can include a blowing agent and an at least partially cured intumescent resin. The fire-resistant panel can satisfy at least one of: a Standard Test Method for Extended Duration Surface Burning Characteristics of Building Materials (30 min Tunnel Test) according to ASTM E2768-11(2018) and a Standard Test Method for Fire Tests of Building Construction and Materials according to ASTM E119-20.

In some embodiments, a process for making a fire-resistant overlay can include applying a coating to at least one side of a fiber mat that can include a plurality of fibers. The coating can include an intumescent resin and a blowing agent. The process can asl include at least partially curing the intumescent resin to produce the fire-resistant overlay. When the at least one side of the fiber mat that includes the coating disposed thereon is subjected to a modified standard test method for flame resistance of textiles, ASTM D6413-99, where the test is modified by using a run time of 5 minutes instead of 12 seconds, a char can be produced. The char can have a density of about 0.05 g/cm³ to about 0.2 g/cm³, a length of about 8.8 cm to about 10.2, a height of about 1.25 cm to about 2.5 cm, and an expansion ratio of about 10 to about 17.5.

In some embodiments, a process for making a fire-resistant panel can include securing a first side of a fiber mat to a substrate. The fiber mat can include a plurality of fibers secured to one another and have the first side and a second side opposed to one another. The fiber mat can have a thickness extending from a surface of the first side to a surface of the second side. A coating can be disposed on the second side of the fiber mat. The coating can include a blowing agent and an at least partially cured intumescent resin. The fire-resistant panel can satisfy at least one of: a Standard Test Method for Extended Duration Surface Burning Characteristics of Building Materials (30 min Tunnel Test) according to ASTM E2768-11(2018) and a Standard Test Method for Fire Tests of Building Construction and Materials ASTM E119-20.

### DETAILED DESCRIPTION

The fire-resistant overlay can include a fiber mat that can include a plurality of fibers secured to one another and have a first side and a second side opposed to one another. The fiber mat can have a thickness extending from a surface of the first side to a surface of the second side. In some embodiments, the fiber mat can have a thickness of about 0.3 mm to about 1.5 mm. A coating can be disposed on at least one of the first side and the second side of the fiber mat. The coating can include a blowing agent and an at least partially cured intumescent resin. When a side of the fiber mat that includes the coating disposed thereon is subjected to a modified standard test method for flame resistance of textiles, ASTM1 D6413-99, where the test is modified by using a run time of 5 minutes instead of 12 seconds, a char can be produced. In some embodiments, the char can have a density of about 0.05 g/cm³ to about 0.2 g/cm³, a length of about 8.8 cm to about 10.2 cm, a height of about 1.25 cm to about 2.5 cm, and an expansion ratio of about 10 to about 17.5.

The density of the char can be measured according to ASTM C914-09(2022). The length of the char, which can also be referred to as the char travel length, is the distance extending from an edge of the sample where intumescence was produced that was closest to the Bunsen burner used to carry out the ASTM D6413-99 test to the highest point on the sample where intumescence was produced. The length of the char can be measured via a caliper. The char height can be the distance a surface of the char extends away from the side of the fire-resistant overlay that is opposite a surface of the char. The char height can be measured using a caliper by measuring the distance the surface of the char extends away from the side of the fire-resistant overlay that is opposite the surface of the char.

The expansion ratio is the ratio of the combined thickness of the fiberglass mat and char after subjecting the fire-resistant overlay to the modified ASTM D6413-99 test divided by the original thickness of the fiberglass mat and the coating disposed thereon. The original thickness of the fire-resistant overlay, prior to subjecting the fire-resistant overlay to the modified ASTM D6413-99 test, can be measured using a material thickness gauge that can have a sensitivity to the ten thousandths of a millimeter. In some embodiments, the thickness of the fire-resistant overly, prior to subjecting the fire-resistant overlay to the modified ASTM D6413-99 test, can be measured with a Model MTG-DX2—material thickness gauge available from Rex Gauge Company, Inc. After the fire-resistant overlay is subjected to the modified ASTM D6413-99 test, the thickness of the char can be measured using a digital caliper that can have a sensitivity to the ten thousandths of a millimeter.

In some embodiments, the char can have a density of about 0.05 g/cm³, about 0.055 g/cm³, about 0.057 g/cm³, about 0.06 g/cm³, about 0.065 g/cm³, about 0.07, about 0.08 g/cm³, about 0.09 g/cm³, or about 0.1 g/cm³ to about 0.11 g/cm³, about 0.12 g/cm³, about 0.13 g/cm³, about 0.14 g/cm³, about 0.15 g/cm³, about 0.16 g/cm³, about 0.17 g/cm³, about 0.18 g/cm³, about 0.19 g/cm³, or about 0.2 g/cm³. In other embodiments, the char can have a density of at least 0.05 g/cm³, at least 0.055 g/cm³, at least 0.057 g/cm³, at least 0.06 g/cm³, at least 0.065 g/cm³, at least 0.07, at least 0.08 g/cm³, at least 0.09 g/cm³, or at least 0.1 g/cm³ up to 0.11 g/cm³, 0.12 g/cm³, 0.13 g/cm³, 0.14 g/cm³, 0.15 g/cm³, 0.16 g/cm³, 0.17 g/cm³, 0.18 g/cm³, 0.19 g/cm³, or 0.2 g/cm³.

In some embodiments, the char can have a length of about 8.8 cm, about 8.9 cm, about 9 cm, about 9.1 cm, about 9.2 cm, or about 9.3 cm to about 9.5 cm, about 9.6 cm, about 9.7 cm, about 9.8 cm, about 9.9 cm, about 10 cm, about 10.1 cm, or about 10.2 cm. In other embodiments, the char can have a length of at least 8.8 cm, at least 8.9 cm, at least 9 cm, at least 9.1 cm, at least 9.2 cm, or at least 9.3 cm up to 9.5 cm, 9.6 cm, 9.7 cm, 9.8 cm, 9.9 cm, 10 cm, 10.1 cm, or 10.2 cm.

In some embodiments, the char can have a height of about 1.25 cm, about 1.3 cm, about 1.4 cm, about 1.5 cm, about 1.6 cm, or about 1.7 cm to about 1.8 cm, about 1.9 cm, about 2 cm, about 2.1 cm, about 2.2 cm, about 2.3 cm, about 2.4 cm, or about 2.5 cm. In other embodiments, the char can have a height of at least 1.25 cm, at least 1.3 cm, at least 1.4 cm, at least 1.5 cm, at least 1.6 cm, or at least 1.7 cm up to 1.8 cm, 1.9 cm, 2 cm, 2.1 cm, 2.2 cm, 2.3 cm, 2.4 cm, or 2.5 cm.

In some embodiments, the char can have an expansion ratio of about 10, about 10.5, about 11, about 11.5, about 12, about 12.5, about 13, or about 13.5 to about 14, about 14.5, about 15, about 15.5, about 16, about 16.5, about 17, or about 17.5. In other embodiments, the char can have an expansion ratio of at least 10, at least 10.5, at least 11, at least 11.5, at least 12, at least 12.5, 13, or at least 13.5 up to 14, 14.5, 15, 15.5, 16, 16.5, 17, or 17.5.

In some embodiments, the char can have a density of about 0.05 g/cm³ to about 0.2 g/cm³, a length of about 8.9 cm to about 10.1 cm, a height of about 1.28 cm to about 2.5 cm, and an expansion ratio of about 10.5 to about 17.3. In other embodiments, the char can have a density of about 0.05 g/cm³ to about 0.2 g/cm³, a length of about 9.0 cm to about 10.0, a height of about 1.3 cm to about 2.43 cm, and an expansion ratio of about 10.7 to about 17.1.

As described in more detail below, the fiber mat can have a thickness of about 0.3 mm to about 1.5 mm. In some embodiments, a thickness of the coating disposed on the at least one side of the fiber mat can have a thickness of about 0.03 mm, about 0.04 mm, about 0.06 mm, about 0.08 mm, about 0.1 mm, about 0.2 mm, about 0.4 mm, about 0.5 mm, about 0.7 mm, about 1 mm, about 1.5 mm, about 2 mm, about 3 mm, about 5 mm, about 7 mm, or about 10 mm to about 12 mm, about 14 mm, about 16 mm, about 18 mm, about 20 mm, about 22 mm, about 24 mm, or about 26 mm. The thickness of the coating can be determined by subtracting the thickness of the fiber mat from a thickness of the fire-resistant overlay prior to subjecting the fire-resistant overlay to the modified ASTM D6413-99 test. The thickness of the fiber mat prior to applying the coating thereto and the thickness of the fire-resistant overlay can be measured using a material thickness gauge with a sensitivity to the ten thousandths of a millimeter. In some embodiments, the thickness of the fiber mat and the fire-resistant overlay can be measured with a Model MTG-DX2—material thickness gauge available from Rex Gauge Company, Inc. After subjecting the fire-resistant overlay to the modified ASTM D6413-99 test, the thickness of the coating that has intumesced can be measured using a digital caliper with a sensitivity to the ten thousandths of a millimeter.

In some embodiments, the coating can include about 40 wt %, about 45 wt %, about 47 wt %, about 50 wt %, about 52 wt %, about 55 wt %, about 57 wt %, about 60 wt %, about 63 wt %, about 65 wt %, about 70 wt %, or about 75 wt % to about 80 wt %, about 83 wt %, about 85 wt %, about 87 wt %, about 90 wt %, or about 92 wt % of the at least partially cured intumescent resin, based on a combined solids weight of the at least partially cured intumescent resin and the blowing agent. Likewise, the coating can include about 8 wt %, about 10 wt %, about 15 wt %, about 17 wt %, about 20 wt %, about 23 wt %, about 25 wt %, or about 27 wt % to about 33 wt %, about 35 wt %, about 37 wt %, about 40 wt %, about 43 wt %, about 45 wt %, about 48 wt %, about 50 wt %, about 53 wt %, about 55 wt %, or about 60 wt % of the blowing agent, based on a combined solids weight of the at least partially cured intumescent resin and the blowing agent. In other embodiments, the coating can include about 43 wt %, about 44 wt %, about 45 wt %, or about 46 wt % to about 53 wt %, about 54 wt %, about 55 wt %, about 56 wt %, or about 57 wt % of the at least partially cured intumescent resin, based on a combined solids weight of the at least partially cured intumescent resin and the blowing agent. Likewise, the coating can include about 43 wt %, about 44 wt %, about 45 wt %, about 46 wt %, or about 47 wt % to about 54 wt %, about 55 wt %, about 56 wt %, or about 57 wt % of the blowing agent, based on the combined solids weight of the at least partially cured intumescent resin and the blowing agent. In some embodiments, the fire-resistant overlay can include a greater amount of the at least partially cured intumescent resin than the blowing agent. In other embodiments the fire-resistant overlay can include a greater amount of the blowing agent than the at least partially cured intumescent resin.

In some embodiments, the fire-resistant overlay can include about 20 wt %, about 23 wt %, about 25 wt %, about 27 wt %, or about 30 wt % to about 33 wt %, about 35 wt %, about 37 wt %, about 40 wt %, about 43 wt %, about 45 wt %, about 47 wt %, or about 50 wt % of the fiber mat, based on the total weight of the fire-resistant overlay. The total weight of the fire-resistant overlay is equal to the total solids weight of the fiberglass mat including the weight of any secondary coating (described in more detail below) if present+the solids weight of the intumescent resin in the fire-resistant overlay+the solids weight of the blowing agent in the fire-resistant overlay. In other embodiments, the fire-resistant overlay can include about 29 wt %, about 30 wt %, or about 31 wt % to about 33 wt %, about 35 wt %, or about 37 wt % of the fiber mat, based on the total weight of the fire-resistant overlay.

In some embodiments, the fire-resistant overlay can include about 23 wt %, about 25 wt %, about 27 wt %, or about 29 wt % to about 35 wt %, about 37 wt %, about 39 wt %, about 41 wt %, about 43 wt %, or about 45 wt % of the at least partially cured intumescent resin, based on the total weight of the fire-resistant overlay. In other embodiments, the fire-resistant overlay can include about 30 wt %, about 32 wt %, about 33 wt %, or about 34 wt % to about 36 wt %, about 37 wt %, about 38 wt %, or about 39 wt % of the at least partially cured intumescent resin, based on the combined weight of the at least partially cured intumescent resin, the blowing agent, and the fiber mat.

In some embodiments, the fire-resistant overlay can include about 23 wt %, about 25 wt %, about 27 wt %, or about 29 wt % to about 35 wt %, about 37 wt %, about 39 wt %, about 41 wt %, about 43 wt %, or about 45 wt % of the blowing agent, based on the total weight of the fire-resistant overlay. In other embodiments, the fire-resistant overlay can include about 28 wt %, about 29 wt %, about 30 wt %, or about 31 wt % to about 33 wt %, about 35 wt %, about 37 wt %, or about 39 wt % of the blowing agent, based on the combined weight of the at least partially cured intumescent resin, the blowing agent, and the fiber mat.

In some embodiments, the fire-resistant overlay can include about 50 wt %, about 55 wt %, about 57 wt %, about 60 wt %, about 61 wt %, or about 63 wt % to about 71 wt %, about 73 wt %, about 75 wt %, about 77 wt %, or about 80 wt % of a combined amount of the at least partially cured intumescent resin and the blowing agent, based on the total weight of the fire-resistant overlay. In other embodiments, the fire-resistant overlay can include about 62 wt %, about 63 wt %, or about 64 wt % to about 68 wt %, 70 wt %, or about 72 wt % of a combined amount of the at least partially cured intumescent resin and the blowing agent, based on the total weight of the fire-resistant overlay.

In some embodiments, the fire-resistant overlay can include about 29 wt %, about 30 wt %, or about 31 wt % to about 33 wt %, about 35 wt %, or about 37 wt % of the fiber mat, about 30 wt %, about 32 wt %, about 33 wt %, or about 34 wt % to about 36 wt %, about 37 wt %, about 38 wt %, or about 39 wt % of the at least partially cured intumescent resin, and about 28 wt %, about 29 wt %, about 30 wt %, or about 31 wt % to about 33 wt %, about 35 wt %, about 37 wt %, or about 39 wt % of the blowing agent, based on the total weight of the fire-resistant overlay. In some embodiments, the fire-resistant overlay can include about 29 wt %, about 30 wt %, or about 31 wt % to about 33 wt %, about 35 wt %, or about 37 wt % of the fiber mat, about 30 wt %, about 32 wt %, about 33 wt %, or about 34 wt % to about 36 wt %, about 37 wt %, about 38 wt %, or about 39 wt % of the at least partially cured intumescent resin, about 28 wt %, about 29 wt %, about 30 wt %, or about 31 wt % to about 33 wt %, about 35 wt %, about 37 wt %, or about 39 wt % of the blowing agent, and about 62 wt %, about 63 wt %, or about 64 wt % to about 68 wt %, 70 wt %, or about 71 wt % of a combined amount of the at least partially cured intumescent resin and the blowing agent, based on the total weight of the fire-resistant overlay.

### Intumescent Resin

The intumescent resin in the coating can include any resin that, when exposed to a sufficiently high surface temperature or flames, can swell, foam, or otherwise expand. The expanded intumescent resin or char can be a poor conductor of heat, which can retard the transfer of heat through the char, thus slowing the rate of heat transfer through the char and into the substrate. In some embodiments, the intumescent resin can be or can include, but is not limited to, one or more aldehyde-based resins, one or more polyacrylates, one or more polyurethanes, one or more epoxy resins having phenolic cross-linkers, one or more polystyrenes, one or more halogenated polymers, or a mixture thereof.

### Aldehyde-Based Resin

The aldehyde-based resin can be or can include, but is not limited to, one or more urea-formaldehyde resins, one or more melamine-formaldehyde resins, one or more melamine-urea-formaldehyde resins, one or more melamine-urea-phenol-formaldehyde resins, one or more phenol-formaldehyde resins, one or more phenol-urea-formaldehyde resins, one or more resorcinol-formaldehyde resins, one or more resorcinol-phenol-formaldehyde resins, one or more resorcinol-urea-formaldehyde resins, one or more resorcinol-urea-phenol-formaldehyde resins, one or more aldehyde-based oligomers having (1) one or more polyalcohol-monoether groups covalently bonded thereto, (2) one or more polyalcohol-polyether groups covalently bonded thereto, or (3) one or more polyalcohol-monoether groups and one or more polyalcohol-polyether groups covalently bonded thereto, or any mixture thereof.

If the aldehyde-based resin includes the urea-formaldehyde resin, the urea-formaldehyde resin can have a formaldehyde to urea (F:U) molar ratio of about 0.60:1, about 0.80:1, about 1.0:1, about 1.05:1, about 1.1:1, about 1.15:1, about 1.2:1, about 1.3:1, about 1.4:1, or about 1.5:1 to about 2:1, about 3:1, about 4:1, or about 5:1. In some embodiments, the urea-formaldehyde resin can have a formaldehyde to urea molar ratio of about 1.1:1 to about 3.5:1, about 1.2:1 to about 3:1, about 1.15:1 to about 2.5:1, or about 1.1:1 to about 1.3:1.

If the aldehyde-based resin includes the melamine-formaldehyde resin, the melamine-formaldehyde resin can have a formaldehyde to melamine (F:M) molar ratio of about 1:1, about 1.2:1, about 1.4:1, about 1.5:1, about 1.7:1, about 2:1, or about 3:1 to about 4:1, about 5:1, or about 6:1. In some embodiments, the melamine-formaldehyde resin can have a formaldehyde to melamine molar ratio of about 1:1 to about 2.5:1, about 2:1 to about 4.5:1, about 3:1 to about 6:1, about 3:1 to about 5:1, about 3.5:1 to about 5.5:1, about 4.5:1 to about 6:1, about 5:1 to about 6:1, or about 5.5:1 to about 5.8:1.

If the aldehyde-based resin includes the melamine-urea-formaldehyde resin, the melamine-urea-formaldehyde resin can have a formaldehyde to total melamine and urea (F:(M+U)) molar ratio of about 0.60:1, about 0.80:1, about 1.0:1, about 1.05:1, about 1.1:1, about 1.15:1, about 1.2:1, about 1.3:1, about 1.4:1, or about 1.5:1 to about 2:1, about 3:1, about 4:1, or about 5:1. For example, the melamine-urea-formaldehyde resin can have a formaldehyde to total melamine and urea molar ratio of about 0.7:1, about 0.8:1, or about 0.9:1 to about 1.1:1, about 1.15:1, or about 1.2:1.

If the aldehyde-based resin includes the phenol-formaldehyde resin, the phenol-formaldehyde resin can have a formaldehyde to phenol (F:P) molar ratio of about 1:1, about 1.5:1, or about 1.7:1 to about 2:1, about 2.5:1, or about 3:1. For example, the phenol-formaldehyde resin can have a formaldehyde to phenol molar ratio of about 1.5:1, about 1.8:1, or about 2:1 to about 2.2:1, about 2.4:1, or about 2.6:1.

If the aldehyde-based resin includes the resorcinol-formaldehyde resin, the resorcinol-formaldehyde resin can have a formaldehyde to resorcinol (F:R) molar ratio of a about 1:1, about 1.5:1, or about 1.7:1 to about 2:1, about 2.5:1, or about 3:1. For example, the resorcinol-formaldehyde resin can have a formaldehyde to resorcinol molar ratio of about 1.5:1, about 1.8:1, or about 2:1 to about 2.2:1, about 2.4:1, or about 2.6:1.

If the aldehyde-based resin includes the phenol-resorcinol-formaldehyde resin, the phenol-resorcinol-formaldehyde resin can have a formaldehyde to total phenol and resorcinol (F:(P+R)) molar ratio of about 1:1, about 1.5:1, or about 1.7:1 to about 2:1, about 2.5:1, or about 3:1. For example, the phenol-resorcinol-formaldehyde resin can have a formaldehyde to total phenol and resorcinol molar ratio of about 1.5:1, about 1.8:1, or about 2:1 to about 2.2:1, about 2.4:1, or about 2.6:1.

The aldehyde compound in the aldehyde-based resin can be or include one or more substituted aldehyde compounds, one or more unsubstituted aldehyde compounds, or any mixture thereof. Illustrative aldehyde compounds can include, but are not limited to, aldehydes having the chemical formula RCHO, where R is hydrogen or a hydrocarbyl group. Illustrative hydrocarbyl groups can include 1 carbon atom to about 8 carbon atoms. Suitable aldehyde compounds can also include the so-called masked aldehydes or aldehyde equivalents, such as acetals or hemiacetals. Specific aldehyde compounds can include, but are not limited to, formaldehyde, paraformaldehyde, cinnamaldehyde, tolualdehyde, acetaldehyde, propionaldehyde, butyraldehyde, furfural, benzaldehyde, retinaldehyde, glyoxal, malondialdehyde, succindialdehyde, glutaraldehyde, phthaldehyde, derivatives thereof, or any mixture thereof. Still other suitable formaldehyde compounds can include formaldehyde present in a prepolymer or precondensate, such as urea-formaldehyde condensate (UFC) or UF precondensate. In at least one embodiment, the aldehyde compound can be or include formaldehyde.

The phenolic compound, when used to produce the aldehyde-based resin, can be or can include phenol (also known as monohydroxybenzene), one or more substituted phenol compounds, or any combination or mixture thereof. Illustrative substituted phenol compounds can include, but are not limited to, alkyl-substituted phenols such as the cresols and xylenols; cycloalkyl-substituted phenols such as cyclohexyl phenol; alkenyl-substituted phenols; aryl-substituted phenols such as p-phenyl phenol; alkoxy-substituted phenols such as 3,5-dimethyoxyphenol; aryloxy phenols such as p-phenoxy phenol; halogen-substituted phenols such as p-chlorophenol, or any mixture thereof. Dihydric phenols such as catechol, resorcinol, hydroquinone, bisphenol A and bisphenol F also can also be used. In some embodiments, the phenolic compound can be or can include, but is not limited to, resorcinol, phenol, catechol, hydroquinone, pyrogallol, 5-methylresorcinol, 5-ethylresorcinol, 5-propylresorcinol, 4-methylresorcinol, 4-ethylresorcinol, 4-propylresorcinol, resorcinol monobenzoate, resorcinol monosinate, resorcinol diphenyl ether, resorcinol monomethyl ether, resorcinol monoacetate, resorcinol dimethyl ether, phloroglucinol, benzoylresorcinol, resorcinol rosinate, alkyl substituted resorcinol, aralkyl substituted resorcinol, 2-methylresorcinol, phloroglucinol, 1,2,4-benzenetriol, 3,5-dihydroxybenzaldehyde, 2,4-dihydroxybenzaldehyde, 4-ethylresorcinol, 2,5-dimethylresorcinol, 5-methylbenzene-1,2,3-triol, 3,5-dihydroxybenzyl alcohol, 2,4,6-trihydroxytoluene, 4-chlororesorcinol, 2′,6′-dihydroxyacetophenone, 2′,4′-dihydroxyacetophenone, 3′,5′-dihydroxyacetophenone, 2,4,5-trihydroxybenzaldehyde, 2,3,4-trihydroxybenzaldehyde, 2,4,6-trihydroxybenzaldehyde, 3,5-dihydroxybenzoic acid, 2,4-dihydroxybenzoic acid, 2,6-dihydroxybenzoic acid, 1,3-dihydroxynaphthalene, 2′,4′-dihydroxypropiophenone, 2′,4′-dihydroxy-6′-methylacetophenone, 1-(2,6-dihydroxy-3-methylphenyl)ethanone, 3-methyl 3,5-dihydroxybenzoate, methyl 2,4-dihydroxybenzoate, gallacetophenone, 2,4-dihydroxy-3-methylbenzoic acid, 2,6-dihydroxy-4-methylbenzoic acid, methyl 2,6-dihydroxybenzoate, 2-methyl-4-nitroresorcinol, 2,4,5-trihydroxybenzoic acid, 3,4,5-trihydroxybenzoic acid, 2,3,4-trihydroxybenzoic acid, 2,4,6-trihydroxybenzoic acid, 2-nitrophloroglucinol, or any mixture thereof. In at least one embodiment, the urea-modified aldehyde-based resin can be or include phenol, resorcinol, or a mixture thereof.

The urea compound, when used to produce the aldehyde-based resin, can be provided in many forms. For example, solid urea, such as prill, and/or urea solutions, typically aqueous solutions, are commonly available. Further, the urea component can be combined with another moiety, for example, formaldehyde and/or urea-formaldehyde adducts, often in aqueous solution. Any form of urea or urea in combination with formaldehyde (or other aldehyde(s)) can be used to make the urea-modified aldehyde-based resin. Both urea prill and combined urea-aldehyde products can be used. Illustrative urea-formaldehyde products can include, but are not limited to, Urea Formaldehyde (UFC). These types of products can include those described in U.S. Pat. Nos. 5,362,842 and 5,389,716, for example.

Melamine, if present in the aldehyde-based resin, can also be provided in many forms. For example, solid melamine, such as prill and/or melamine solutions can be used. Although melamine is specifically referred to, in some embodiments, the melamine can be totally or partially replaced with other aminotriazine compounds. Other suitable aminotriazine compounds can be or can include, but are not limited to, substituted melamines, cycloaliphatic guanamines, or combinations thereof. Substituted melamines include the alkyl melamines and aryl melamines that can be mono-, di-, or tri-substituted. In the alkyl substituted melamines, each alkyl group can contain 1-6 carbon atoms and, preferably 1-4 carbon atoms. Illustrative examples of the alkyl-substituted melamines can include, but are not limited to, monomethyl melamine, dimethyl melamine, trimethyl melamine, monoethyl melamine, and 1-methyl-3-propyl-5-butyl melamine. In the aryl-substituted melamines, each aryl group can contain 1-2 phenyl radicals and, preferably, one phenyl radical. Illustrative examples of aryl-substituted melamines can include, but are not limited to, monophenyl melamine and diphenyl melamine. Any of the cycloaliphatic guanamines can also be used. Suitable cycloaliphatic guanamines can include those having 15 or less carbon atoms. Illustrative cycloaliphatic guanamines can include, but are not limited to, tetrahydrobenzoguanamine, hexahydrobenzoguanamine, 3-methyl-tetrahydrobenzoguanamine, 3-methylhexahydrobenzoguanamine, 3,4-dimethyl-1,2,5,6-tetrahydrobenzoguanamine, and 3,4-dimethylhexahydrobenzoguanamine and mixtures thereof. Mixtures of aminotriazine compounds can include, for example, melamine and an alkyl-substituted melamine, such as dimethyl melamine, or melamine and a cycloaliphatic guanamine, such as tetrahydrobenzoguanamine.

In some embodiments, the aldehyde-based resin can include about 3 wt %, about 3.5 wt %, about 4 wt %, about 4.5 wt %, about 5 wt %, or about 5.5 wt % to about 6 wt %, about 6.5 wt %, about 7 wt %, about 7.5 wt %, about 8 wt %, about 8.5 wt %, or about 9 wt % of one or more base compounds, based on the solids weight of the aldehyde-based resin. In other embodiments, aldehyde-based resin can include about 0.05 wt %, about 0.1 wt %, about 0.3 wt %, about 0.5 wt %, about 0.7 wt %, about 1 wt %, about 2 wt %, about 2.5 wt %, about 3 wt %, about 3.5 wt %, about 4 wt %, about 4.5 wt %, about 4.8 wt %, or about 5 wt % to about 6 wt %, about 8 wt %, about 10 wt %, about 11 wt %, about 12 wt %, or about 13 wt % of the one or more base compounds, based on the solids weight of the aldehyde-based resin.

The base compound(s), if present, can be or can include, but is/are not limited to, one or more hydroxides, one or more carbonates, ammonia, one or more amines, one or more borates, or any mixture thereof. Illustrative hydroxides can be or can include, but are not limited to, sodium hydroxide, potassium hydroxide, ammonium hydroxide (e.g., aqueous ammonia), lithium hydroxide, calcium hydroxide, and cesium hydroxide. Illustrative carbonates can be or include, but are not limited to, sodium carbonate, sodium bicarbonate, potassium carbonate, calcium carbonate, and ammonium carbonate. Illustrative amines can be or can include, but are not limited to, trimethylamine, triethylamine, triethanolamine, diisopropylethylamine (Hunig's base), pyridine, 4-dimethylaminopyridine (DMAP), and 1,4-diazabicyclo[2.2.2]octane (DABCO). Illustrative borates can be or can include, but are not limited to, sodium borate, potassium borate, calcium borate, and zinc borate. The alkaline reagent can be used to adjust the pH of the aldehyde-based resin.

Many aldehyde-based resins that can be used are commercially available. One particularly useful class of aldehyde-based resins can include those discussed and described in U.S. Pat. No. 5,362,842. Urea-formaldehyde resins such as the types sold by Georgia-Pacific Chemicals LLC, e.g., GP® 2928 and GP® 2980, can also be used.

### Polyacrylates

In some embodiments, the polyacrylate can be or can include one or more (meth)acrylic copolymers, one or more 2-ethylhexylacrylates, or a mixture thereof. In some embodiments, the (meth)acrylic copolymer can be formed from, on a wt % basis, a majority of, i.e., >50 wt % such as from about 90 wt % to about 99 wt %, of one or more ethylenically unsaturated monomers and an effective minor amount, i.e., <50 wt % such as about 1 wt % to about 10 wt %, of one or more copolymerizable thermally labile co-monomers, where the amount of the co-monomer is sufficient to cause the resultant copolymer to decompose and expand when exposed to sufficient heat or flame. In some embodiments, the ethylenically unsaturated monomer can be or can include, but is not limited to, an ester of a lower alkyl(C₁-C₄)(meth)acrylic acid, vinyl acetate, styrene, or a mixture thereof. In some embodiments, the co-monomer can be a free radical generating compound containing a carbon atom double bonded to an oxygen atom. In some embodiments, the co-monomer can be a monomeric aldehyde. In some embodiments, the co-monomer can be acrolein, methacrolein, crotonaldehyde, or a mixture thereof.

In some embodiments, the intumescent resin can be in the form of a copolymer composition that can include a blend of a Newtonian copolymer and a reticulated copolymer, where the Newtonian copolymer can include p-methylstyrene repeat units and 2-ethylhexylacryate repeat units, and where the reticulated copolymer can include p-methylstyrene repeat units and 2-ethylhexylacrylate repeat units. In some embodiments, the Newtonian copolymer can further include p-tert-butylstyrene repeat units and/or the reticulated copolymer can further include p-tert-butylstyrene repeat units. In some embodiments, a ratio of p-methylstyrene to 2-ethylhexylacrylate in the reticulated copolymer can be about 9:1 to about 3:1. In some embodiments, the Newtonian copolymer can further include isobutylmethacrylate and/or the reticulated copolymer can further include isobutylmethacrylate. In some embodiments, the (meth)acrylic copolymer can include the copolymer described in Canadian Patent No. CA 1322069 and the 2-ethylhexylacrylate can include the polyacrylate described in U.S. Pat. No. 7,288,588.

### Polyurethanes

In some embodiments, the polyurethane can be or can include, but is not limited to, a polyurethane foam that can be produced by combining (a) at least one isocyanate component that can include (i) at least one intumescent compound and (ii) at least one isocyanate compound, and (b) at least one polyol component that can include (i) at least one intumescent compound and (ii) at least one polyol compound. In some embodiments, the isocyanate compound can be or can include, but is not limited to, methylene diphenyl diisocyanate (MDI), polymeric methylene diphenyl diisocyanate (pMDI), emulsified polymer isocyanate (EPI), copolymers thereof, isomers thereof, or any mixture thereof. Illustrative MDI resins and pMDI resins can be or include any one or more isomers, such as 2,2′-methylene diphenyl diisocyanate (2,2′-MDI), 2,4′-methylene diphenyl diisocyanate (2,4′-MDI), 4,4′-methylene diphenyl diisocyanate (4,4′-MDI), or any mixture thereof. In some embodiments, the isocyanate-based resin can be or include pMDI, such as DESMODUR® 44V20L resin, commercially available from Covestro. In some embodiments, the polyol compound can be or can include, but is not limited to, polyols having two or more groups containing an active hydrogen atom capable of undergoing reaction with an isocyanate. In one embodiment, such polyols can include compounds having at least two hydroxyl, primary or secondary amine, carboxylic acid, or thiol groups per molecule. In some embodiments, the polyurethane can include the polyurethanes described in U.S. Pat. No. 9,745,440.

Epoxy Resin with Phenolic Cross-Linkers

In some embodiments, the epoxy resin can include (a) a bisphenol A epoxy resin, (b) a dicyandiamide curing agent, (c) red phosphorous particles at least partially coated in a layer formed of a resin, and (d) an inorganic filler. In some embodiments, the red phosphorus particles can be at least partially coated with two layers, where a first or inner layer includes aluminum hydroxide and/or zinc hydroxide and a second or outer layer that is made of a phenolic resin. In some embodiments, components (a) and (b) can be present in the epoxy resin such that about 0.8 to about 1.2 epoxy equivalents of component (a) exist per hydroxyl equivalent of component (b). In some embodiments, components (a) and (b) can be present in the epoxy resin in an amount of about 50 wt % to about 90 wt %, based on a total weight of the epoxy resin. In some embodiments, the epoxy resin can include the epoxy resin compositions described in U.S. Pat. No. 5,994,429.

### Polystyrene

In some embodiments, the intumescent resin can include a polystyrene that can be combined with (a) a polyphosphate compound having formula (1), (b) a (poly)phosphate compound having formula (3), and (c) a layered silicate in an amount effective to achieve an anti-dripping effect. Formula (1) can be:

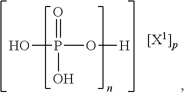

where n can be a number of from 1 to 1,000, X¹ can be ammonia or a triazine derivative represented by formula (2), and p can be a number satisfying the relational expression of 0<p≤n+2. Formula (2) can be:

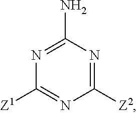

where Z¹ and Z² can independently be a —NR⁵R⁶ group, a hydroxyl group, a mercapto group, a straight chain or branched alkyl group having from 1-10 carbon atoms, a straight chain or branched alkoxy group having from 1-10 carbon atoms, a phenyl group, and a vinyl group, and Rand R can independently be a hydrogen atom, a straight chain or branched alkyl group having from 1-6 carbon atoms, or a methylol group. Formula (3) can be:

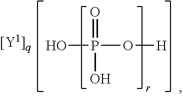

wherein r can be a number from 1 to 100, Y¹ can be a diamine that can include a [R¹R²N(CH₂)mNR³R⁴] group, piperazine, or a diamine containing a piperazine ring, R¹, R², R³, and R⁴ are independently selected from a hydrogen atom or a straight chain or branched alkyl group having from 1-5 carbon atoms, m can be a number from 1-10, and q can be a number satisfying the relational expression of 0<q≤r+2.

In some embodiments, the amount of components (a), (b), and (c) can be about 0.1 mass parts to about 40 mass parts, about 0.1 mass parts to about 50 mass parts, and about 0.01 mass parts to about 15 mass parts of the intumescent resin. In some embodiments, a blending ratio of (a)/(b) (mass standard) can be about 20/80 to about 50/50. In some embodiments, the intumescent resin can be free or substantially free of polylactic acid. In some embodiments, in addition to the polystyrene, the intumescent resin can also include one or more α-olefin polymers or copolymers, a petroleum resin, coumarone resin, polyvinyl acetate, an acrylic resin, a copolymer of styrene and/or a-methylstyrene with one or more other monomers, polyamides, thermoplastic polycarbonate, polycarbonate/ABS resin, branched polycarbonate, polyacetal, polyphenylene sulfide, polyurethane or cellulose resin, isoprene rubber, butadiene rubber, acrylonitrile-butadiene copolymer rubber, styrene-butadiene copolymer rubber elastomer, or any mixture thereof. In some embodiments, the polystyrene can be or can include those described in U.S. Pat. No. 8,324,296.

### Halogenated Polymer

In some embodiments, the halogenated polymer can be or can include a halogenated polymer. Various halogens can be employed in making the halogenated polymer, such as bromine, chlorine, fluorine, iodine and the like, or any mixture thereof. In some embodiments, the halogenated polymer can be or can include, but is not limited to, a chlorinated polyethylene. The chlorinated polyethylene can have a chlorine content of about 25 wt % to about 45 wt %, based on the total weight of the chlorinated polyethylene. In some embodiments, the chlorine content can be ≥32 wt % or ≥36 wt 5, based on the total weight of the chlorinated polyethylene. The chlorinated polyethylene can have a chlorine content of ≤43 wt % or ≤42 wt % based on the total weight of chlorinated polyethylene. In some embodiments, the halogenated polymer can be combined with antimony oxide and/or an intercalated graphite. In some embodiments, the halogenated polymer can be combined with a polymeric resin such as one or more thermoplastic resins, one or more thermosetting resins, or a combination thereof. In some embodiments, the halogenated polymer can be or can include those described in U.S. Pat. No. 6,706,793.

In some embodiments, one or more of the intumescent resins and/or blowing agents can include one or more liquid mediums. Illustrative liquid mediums that the intumescent resin and/or blowing agent can be or can include, but are not limited to, water, one or more alcohols, one or more ethers, one or more other organic solvents, or any mixture thereof. In at least one embodiment, the liquid medium can be water. Illustrative alcohols can include, but are not limited to, methanol, ethanol, propanol, isopropanol, n-butanol, sec-butanol, iso-butanol, tert-butanol, ethylene glycol, or any mixture thereof. Illustrative ethers can include, but are not limited to, dimethyl ether, diethyl ether, tetrahydrofuran, or any mixture thereof.

In some embodiments, prior to at least partially curing the intumescent resin, the coating can include about 50 wt %, about 53 wt %, about 55 wt %, about 57 wt %, about 60 wt %, about 63 wt %, about 65 wt %, about 70 wt %, or about 75 wt % to about 80 wt %, about 85 wt %, about 87 wt %, about 90 wt %, about 93 wt %, about 95 wt %, about 97 wt %, or about 99 wt % of the intumescent resin, based on a combined solids weight of the intumescent resin and the blowing agent. Likewise, prior to at least partially curing the intumescent resin, the coating can include about 1 wt %, about 3 wt %, about 5 wt %, about 7 wt %, about 10 wt %, about 13 wt %, about 15 wt %, or about 20 wt % to about 25 wt %, about 30 wt %, about 35 wt %, about 37 wt %, about 40 wt %, about 43 wt %, about 45 wt %, about 47 wt %, or about 50 wt % of the blowing agent, based on a combined solids weight of the intumescent resin and the blowing agent.

### Blowing Agent

The blowing agent can be or can include any compound that produces a gas upon thermal decomposition that is non-flammable in the presence of oxygen. In some embodiments, the blowing agent can be or can include, but is not limited to, phosphoric acid, ammonium phosphate, triethyl phosphate, triethyl ammonium phosphoric ester, triethanolamine, maleic acid, urea, calcium carbonate, urea formaldehyde, bisphenol, or a mixture thereof. In some specific embodiments, the blowing agent can be or can include, but is not limited to, phosphoric acid, ammonium phosphate, triethyl phosphate, triethyl ammonium phosphoric ester, or a mixture thereof.

In some embodiments, the blowing agent in the coating can be polyphosphoric acids, esters with triethanolamine, as purchased from the Lubrizol Corporation that has a CAS No. of 68131-71-5. The polyphosphoric acids, esters with triethanolamine can also be referred to as polyphosphoric acid, triethanolamine ester; TEA-polyphosphate; triethanolamine polyphosphate ester; and polyphosphoric acids, esters with triethanolamine, sodium salts. In some embodiments, when the blowing agent is or includes the polyphosphoric acids, esters with triethanolamine, the polyphosphoric acids, esters with triethanolamine can have a density of about 1.38 g/cm³ to about 1.42 g/cm³ at a temperature of about 15.6° C. and a flash point of greater than about 94° C.

In some embodiments, the blowing agent, in addition to producing a gas upon thermal decomposition can also serve as a catalyst to promote the at least partial curing of the intumescent resin. In some embodiments, the blowing agent that can also serve as a catalyst to promote the at least partial curing of the intumescent resin during manufacture of the fire-resistant panel can be or can include, but is not limited to, phosphoric acid, ammonium phosphate, triethyl phosphate, triethyl ammonium phosphoric ester, or any mixture thereof. In some embodiments, the blowing agent that can also serve as a catalyst to promote the at least partial curing of the intumescent resin during manufacture of the fire-resistant panel can be or can include, but is not limited to, triethyl ammonium phosphoric ester, which can also be referred to as polyphosphoric acids, esters with triethanolamine that can be purchased from the Lubrizol Corporation that has a CAS No. of 68131-71-5.

### Fiber Mat

The fiber mat can include the plurality of fibers in any desired arrangement. In some embodiments, the fiber mat can be a non-woven fiber mat. In other embodiments, the fiber mat can be a woven fiber mat. In still other embodiments, the fiber mat can include a woven fiber mat that can also include non-woven fibers distributed throughout.

In some embodiments, the fibers in the fiber mat can be secured to one another with an at least partially cured adhesive. In some embodiments, the adhesive can be or can include, but is not limited to, at least a portion of the uncured coating or at least a portion of the uncured intumescent resin minus the blowing agent. In other embodiments, when the uncured coating is used as the adhesive to secure the fibers to one another and to provide the coating on the first and/or second side of the fiber mat, a ratio of the intumescent resin to the blowing agent in the uncured coating used to secure the fibers to one another can be the same or different from a ratio of the intumescent resin to the blowing agent in the uncured coating used to provide the coating on the first and/or second side of the fiber mat. For example, the uncured coating used as the adhesive to secure the fibers to one another can include a greater amount of the intumescent resin relative to the blowing agent than the uncured coating used to provide the coating on the first and/or second surface of the fiber mat or vice versa.

As used herein, the terms “fiber”, “fiberglass”, and “glass fiber” refer to materials that have an elongated morphology exhibiting an aspect ratio (length to diameter) of greater than 100, and generally greater than 500, such as, for example, about 1,000 or greater, about 5,000 or greater, or about 10,000 or greater. In some embodiments, the fibers can have a diameter of about 1 μm, about 3 μm, about 5 μm, about 10 μm, or about 12 μm, to about 13 μm, about 15 μm, about 20 μm, about 25 μm, or about 30 μm. In some embodiments, the glass fibers can have a diameter of about 1 μm to about 30 μm, e.g., about 10 μm, and can be bundled in such that the bundled fibers have a diameter of about 100 μm, about 250 μm, about 500 μm, or about 600 μm to about 700 μm, about 850 μm, or about 1,000 μm.

In some embodiments, the fibers can be or can include, but are not limited to, mineral or “glass” fibers, e.g., silica, ceramic fibers, metal fibers, metal coated mineral fibers, aramid fibers, polyimide fibers, polyacronitrile (PAN) fibers, carbon fibers, or any mixture or combination thereof. In some embodiments, the fibers can be glass fibers. Illustrative mineral fibers can be or can include, but are not limited to, A-type glass fibers, C-type glass fibers, E-type glass fibers, S-type glass fibers, ECR-type glass fibers, WUCS glass fibers, wool glass fibers, or any mixture thereof. In some embodiments, the fibers can be mineral fibers that have been wet use chopped strand (“WUCS”) mineral fibers. The WUCS mineral fibers can be formed by conventional processes known in the art. The WUCS mineral fibers can have a moisture content of about 5%, about 8%, or about 10% to about 20%, about 25%, or about 30%. In some embodiments, suitable glass fibers can include glass fibers described in U.S. Patent Application Publication No. 2018/0079694.

In some embodiments, the plurality of fibers can have an average length of about 0.5 cm, about 1 cm, about 1.5 cm, about 2 cm, about 2.5 cm, or about 3 cm to about 3.5 cm, about 4 cm, about 4.5 cm, about 5 cm, about 5.5 cm, or about 6 cm. In some embodiments, the plurality of fibers can have an average diameter of about 5 μm, about 7 μm or about 10 μm to about 12 μm, about 14 μm, about 16 μm about 18 μm or about 20 μm. In some embodiments, the plurality of fibers can have an average length to diameter ratio of about 10:1 to about 40:1.

In some embodiments, the plurality of fibers in the fiber mat can be “uncoated” or can be “coated”. When the plurality of fibers in the fiber mat are “coated” such “coating” can be referred to as a “secondary coating” that is separate and apart from the coating that includes the at least partially cured intumescent resin and the blowing agent. When the fibers in the fiber mat are “uncoated”, additional ingredients are not added to the fiber mat after the fiber mat is manufactured. When the fibers in the fiber mat are coated with the secondary coating, additional ingredients are added to the fiber mat before any coating is applied thereto. When the fibers in the fiber mat are coated with the secondary coating, the material(s) or compound(s) that can be used as the secondary coating can be or can include, but are not limited to, one or more hydroxides, one or more sulfates, one or more oxides, one or more carbonates, one or more oxides, or any mixture thereof. In some embodiments, when the fibers in the fiber mat are coated with the secondary coating, the material(s) or compound(s) that can be used as the secondary coating can be or can include, but are not limited to, calcium carbonate, sodium carbonate, aluminum hydroxide, magnesium hydroxide, huntite, one or more sulfates, or any mixture thereof. In some embodiments, the material(s) or compound(s) used to coat the fibers as the secondary coating can be or can include a blowing agent. In some embodiments, when the fiber mat is coated with a secondary coating that includes a blowing agent, the blowing agent in the secondary coating can be referred to as a “fourth” blowing agent. In some embodiments, when the fiber mat includes a secondary coating that does not include a blowing agent, the secondary coating can be a non-blowing agent compound, e.g., a silicate-based compound such as kaolinite, perlite, vermiculite, diatomite, etc. In other embodiments, the secondary coating can include a blowing agent and a non-blowing agent.

In some embodiments, the fiber mat can have an average thickness of about 0.3 mm, about 0.4 mm, about 0.5 mm, about 0.6 mm, about 0.7 mm, or about 0.75 mm to about 0.8 mm, about 0.85 mm, about 0.9 mm, about 0.95 mm, about 1 mm, about 1.05 mm, about 1.1 mm, about 1.15 mm, or about 1.5 mm.

In some embodiments, the fiber mat can have a basis weight of about 0.01 g/cm², about 0.05 g/cm², about 0.1 g/cm², about 0.5 g/cm², or about 0.7 g/cm² to about 1 g/cm², about 1.2 g/cm², about 1.4 g/cm², about 1.5 g/cm², about 1.6 g/cm², about 1.7 g/cm², about 1.8 g/cm², about 1.9 g/cm², about 2 g/cm², about 2.2 g/cm², about 2.5 g/cm². In other embodiments, the fiber mat can have a basis weight of about 0.01 g/cm², about 0.013 g/cm², about 0.015 g/cm², about 0.017 g/cm², or about 0.02 g/cm² to about 0.023 g/cm², about 0.025 g/cm², about 0.027 g/cm², about 0.03 g/cm², about 0.033 g/cm², about 0.035 g/cm², about 0.037 g/cm², or about 0.04 g/cm².

### Adhesive

In addition to any of the intumescent resins described above, the adhesive that can be used to bond the fibers to one another can be or can include, but are not limited to, one or more acrylic adhesives, bisphenol epoxy adhesives such as a bisphenol epoxy powder, styrene-butadiene rubber, or any mixture thereof. In some embodiments, the adhesive that can be used to bond the fibers to one another can be or can include, but are not limited to, an acrylic adhesive, a bisphenol epoxy adhesive, a styrene butadiene rubber, or any mixture thereof.

In some embodiments, the acrylic adhesive (or alternatively acrylic-type polymer) can be or can include, but are not limited to, polymers or co-polymers containing units derived from one or more of acrylic acid, methacrylic acid and their esters and related derivatives. Such acrylic adhesives can be either a thermosetting acrylic latex or a thermoplastic acrylic latex (also known as an elastomeric acrylic latex). Blends of both thermosetting and thermoplastic acrylic-type polymers, such as an equal weight blend of a thermoplastic and thermosetting polymer, can be used to advantage as the adhesive. Such polymers and copolymers are well known and are widely available commercially. As a result, such polymers do not need to be described in detail. Such polymers and copolymers usually can be put into aqueous solution or are supplied as an aqueous latex emulsion. For example, suitable acrylic adhesives, and particularly aqueous-based latex adhesives, can be made by emulsion polymerization using one or more of the following monomers: (meth)acrylic acid (where the convention (meth)acrylic is intended to embrace both acrylic and methacrylic), 2-hydroxyethyl(meth)acrylate, 2-hydroxypropyl(meth)acrylate, 2-hydroxybutyl(meth)acrylate, methyl(meth)acrylate, ethyl(meth)acrylate, propyl(meth)acrylate, isopropyl(meth)acrylate, butyl(meth)acrylate, amyl(meth)acrylate, isobutyl(meth)acrylate, t-butyl(meth)acrylate, pentyl(meth)acrylate, isoamyl(meth)acrylate, hexyl(meth)acrylate, heptyl(meth)acrylate, octyl(meth)acrylate, isooctyl(meth)acrylate, 2-ethylhexyl(meth)acrylate, nonyl(meth)acrylate, decyl(meth)acrylate, isodecyl(meth)acrylate, undecyl(meth)acrylate, dodecyl(meth)acrylate, lauryl(meth)acrylate, octadecyl(meth)acrylate, stearyl(meth)acrylate, tetrahydrofuryl(meth)acrylate, butoxyethyl(meth)acrylate, ethoxydiethylene glycol (meth)acrylate, benzyl(meth)acrylate, cyclohexyl(meth)acrylate, phenoxyethyl(meth)acrylate, polyethylene glycol mono(meth)acrylate, polypropylene glycol mono(meth)acrylate, methoxyethylene glycol (meth)acrylate, ethoxyethoxyethyl(meth)acrylate, methoxypolyethylene glycol (meth)acrylate, methoxypolypropylene glycol (meth)acrylate, dicyclopentadiene(meth)acrylate, dicyclopentanyl(meth)acrylate, tricyclodecanyl(meth)acrylate, isobornyl(meth)acrylate, and bornyl(meth)acrylate. Other monomers which can be co-polymerized with the (meth)acrylic monomers, generally in a minor amount, include styrene, diacetone(meth)acrylamide, isobutoxymethyl(meth)acrylamide, N-vinylpyrrolidone, N-vinylcaprolactam, N,N-dimethyl(meth)acrylamide, t-octyl(meth)acrylamide, N,N-diethyl(meth)acrylamide, N,N′-dimethylaminopropyl(meth)acrylamide, (meth)acryloylmorphorine; vinyl ethers such as hydroxybutyl vinyl ether, lauryl vinyl ether, cetyl vinyl ether, and 2-ethylhexyl vinyl ether; maleic acid esters; fumaric acid esters; and similar compounds. In some embodiments, the acrylic adhesive, if used, can be or can include, but is not limited to, one or more of the adhesives described in U.S. Patent Application Publication No. 2010/0048080.

In some embodiments, the bisphenol epoxy adhesive can be or can include, but are not limited to, bisphenol A epoxy resins, bisphenol F epoxy resins, bisphenol S epoxy resins, bisphenol AD epoxy resins, or any mixture thereof. In some embodiments, a suitable bisphenol epoxy adhesive can have a thermally active dicyandiamide cross-linking agent. In some embodiments, the bisphenol epoxy adhesive can include the bisphenol epoxy adhesives described in U.S. Pat. No. 7,083,855.

The adhesive, which can be in a liquid form, e.g., aqueous-based, or a solid form, e.g., powder, can be applied to a wet-laid, non-woven fiber mat using any suitable equipment/process, such as by spray coating, roll coating, curtain coating, and/or a dip and squeeze application. Once the adhesive has been applied to the non-woven mat, the mat can be heated to a temperature of up to about 120° C. to about 150° C. for a period of time of usually up to about 1 minute to 2 minutes to dry and, if needed, at least partially cure the adhesive. The adhesive can be applied in an amount sufficient to provide an integral, self-supporting fiber mat.

In some embodiments, the adhesive that can be used to bond the fibers to one another can be or can include, but is not limited to, a mixture of a urea-formaldehyde resin and an acrylic, a bisphenol epoxy, or a mixture thereof.

In some embodiments, the adhesive that can be used to bond the fibers to one another can be or can include, but is not limited to, a mixture of a urea-formaldehyde resin and an acrylic. In some embodiments, the mixture of the urea-formaldehyde resin and the acrylic can include the urea-formaldehyde resin in an amount of about 40 wt %, about 45 wt %, about 50 wt %, about 55 wt %, about 60 wt %, about 70 wt %, or about 75 wt % to about 80 wt %, about 85 wt %, about 90 wt %, about 95 wt %, or about 99 wt % of the urea-formaldehyde resin, based on the total weight of the urea-formaldehyde resin and the acrylic. In some embodiments, the adhesive can include about 84 wt %, about 86 wt %, or about 88 wt % to about 92 wt %, about 94 wt %, or about 96 wt % of the urea-formaldehyde resin, based on the total weight of the urea-formaldehyde resin and the acrylic.

In some embodiments, the adhesive can be or can include a bisphenol epoxy, e.g., a bisphenol epoxy power. In other embodiments, the adhesive can be or can include a mixture of a bisphenol epoxy, e.g., a bisphenol epoxy powder, and the mixture of a urea-formaldehyde resin and an acrylic. In some embodiments, if the adhesive include the mixture of the bisphenol epoxy and the mixture of the urea-formaldehyde resin and the acrylic, adhesive can include from about 1 wt %, about 5 wt %, about 10 wt %, about 20 wt %, about 30 wt %, about 40, or about 50 wt % to about 60 wt %, about 70 wt %, about 80 wt %, about 85 wt %, about 90 wt %, about 95 wt %, or about 99 wt % of the bisphenol epoxy, based on the total weight of the bisphenol epoxy and the mixture of the urea-formaldehyde resin and the acrylic.

### Fire-Resistant Panels

The fire-resistant panel can include a substrate, the fiber mat, and the coating. Said another way, the fire-resistant panel can include the substrate and the fire-resistant overlay disposed thereon such that at least the side of the fire-resistant overlay that is opposite the side of the fire-resistant overlay disposed on the substrate includes the coating disposed thereon. The fire-resistant panel can satisfy the Standard Test Method for Extended Duration Surface Burning Characteristics of Building Materials (30 min Tunnel Test) according to ASTM E2768-11(2018). In some embodiments, the fire-resistant panel can also satisfy the Standard Test Methods for Fire Tests of Building Construction and Materials according to ASTM E119-20. In other embodiments, the fire-resistant panel can satisfy the Standard Test Method for Extended Duration Surface Burning Characteristics of Building Materials (30 min Tunnel Test) according to ASTM E2768-11(2018) and the Standard Test Methods for Fire Tests of Building Construction and Materials according to ASTM E119-20.

In some embodiments, the first side of the fiber mat can be secured to the substrate with an at least partially cured binder. As used herein, the terms “resin”, “adhesive”, and “binder” each refer to a composition that, prior to curing, is capable of bonding one or more substances together and are used to more readily identify which particular composition that is capable of bonding the one or more substances together is being discussed/described. More particularly, the term “resin” is generally used to describe the component that, when exposed to a sufficiently high surface temperature or flames, can swell, foam, or otherwise expand, the term “adhesive” is generally used to describe the component that can secure the fibers to one another, and the term “binder” is generally used to describe the component that can be used to secure the fire-resistant overlay to the substrate. As described above, it should be understood that the resin, adhesive, and binder, prior to curing, can each have the same composition, can each have a different composition from one another, or two of the resin, the adhesive, and the binder can have the same composition and one of the resin, the adhesive, and the binder can have a different composition from the two of the resin, the adhesive, and the binder that have the same composition. In at least one embodiment, the resin and the adhesive can have the same composition and the composition of the binder can be different than the resin and the adhesive.

In one embodiment, when the coating and the binder, prior to curing, have the same composition, the uncured coating, when applied to the fiber mat, can saturate the fiber mat or can be applied to both the second side and the first side of the fiber mat such that both the first and second sides are at least partially coated with the uncured coating. In this embodiment, the first side of the fiber mat can be placed onto the substrate and the intumescent resin in the uncured coating can be at least partially cured to secure the first side of the fiber mat to the substrate and to produce the coating on the second side of the fiber mat that includes the blowing agent and the at least partially cured intumescent resin. In another embodiment, a first portion of the uncured coating can be applied to the second side of the fiber mat and cured to produce the coating. Then a second portion of the uncured coating can be applied to the first side of the fiber mat and/or the substrate and the first side of the fiber mat can be placed onto the substrate and the second portion of the coating can be at least partially cured to secure the first side of the fiber mat to the substrate.

In some embodiments, when the coating and the adhesive, prior to curing, have the same composition, a first portion of the uncured coating can be applied to the fibers and at least partially cured to produce the fiber mat. In such embodiment, a second portion of the uncured coating can be applied to at least one side of the fiber mat to produce the coating on a side of the fiber mat that includes the blowing agent and the at least partially cured intumescent resin. Then a third portion of the uncured coating and/or a binder can be applied to the opposite side of the fiber mat that includes the coating containing the blowing agent and the at least partially cured intumescent resin thereon and the opposite side of the fiber mat can be placed onto the substrate and the third portion of the coating and/or binder can be at least partially cured to secure the fiber mat to the substrate.

In some embodiments, the fire-resistant panel can include about 1 wt % about 1.5 wt %, about 2 wt %, about 2.5 wt %, about 3 wt %, about 3.5 wt %, or about 4 wt % to about 4.5 wt %, about 5 wt %, about 6 wt %, about 7 wt %, about 8 wt %, about 9 wt %, or about 10 wt % of the at least partially cured intumescent resin solids, based on the total weight of the fire-resistant panel. The total weight of the fire-resistant panel is equal to the total weight of the fire-resistant overlay+the solids weight of the substrate+the solids weight of the adhesive. In some embodiments, the fire-resistant panel can include about 1 wt %, about 1.5 wt %, about 2 wt %, about 2.5 wt %, about 3 wt %, about 3.5 wt %, or about 4 wt % to about 4.5 wt %, about 5 wt %, about 6 wt %, about 7 wt %, about 8 wt %, about 9 wt %, or about 10 wt % of the blowing agent solids in the coating, based on the total weight of the fire-resistant panel. In some embodiments, the fire-resistant panel can include about 1 wt %, about 1.5 wt %, about 2 wt %, about 2.5 wt %, about 3 wt %, about 3.5 wt %, or about 4 wt % to about 4.5 wt %, about 5 wt %, about 6 wt %, about 7 wt %, about 8 wt %, about 9 wt %, or about 10 wt % of a total amount of the blowing agent solids, whether the blowing agent is present only in the coating or is present in the coating and one or more other locations, e.g., the adhesive, the binder, and/or the secondary coating that can be disposed on the fiber mat, based on the total weight of the fire-resistant panel.

In some embodiments, the fire-resistant panel can include about 1 wt %, about 1.3 wt %, about 1.5 wt %, about 1.7 wt %, about 2 wt %, about 2.3 wt %, about 2.5 wt %, or about 2.7 wt % to about 3 wt %, about 3.3. wt %, about 3.5 wt %, about 3.7 wt %%, about 4 wt %, about 4.3 wt %, about 4.5 wt %, about 4.7 wt %, about 5 wt %, about 5.5 wt %, about 6 wt %, about 6.5, wt % or about 7 wt % of the plurality of fibers, based on the total weight of the fire-resistant panel.

In some embodiments, the fire-resistant panel can include about 70 wt %, about 73 wt %, about 75 wt %, about 77 wt %, or about 80 wt % to about 81 wt %, about 82 wt %, about 83 wt %, about 84 wt %%, about 85 wt %, about 86 wt %, about 87 wt %, or about 88 wt % of the substrate, based on the total weight of the fire-resistant panel.

In some embodiments, the fire-resistant panel can include about 0.1 wt %, about 0.2 wt %, about 0.3 wt %, about 0.4 wt %, about 0.5 wt %, about 0.53 wt %, about 0.55 wt %, about 0.57 wt %, or about 0.6 wt % to about 0.63 wt %, about 0.65 wt %, about 0.67 wt %, about 0.7 wt %, about 0.73 wt %, about 0.75 wt %, about 0.77 wt %, about 0.8 wt %, about 0.83 wt %, or about 0.85 wt % of the adhesive, based on the total weight of the fire-resistant panel.

In some embodiments, the fire-resistant panel can include about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, or about 1 wt % to about 1.1 wt %, about 1.2 wt %, about 1.3 wt %, about 1.4 wt %, about 1.5 wt %, about 1.6 wt %, about 1.7 wt %, about 1.8 wt %, about 1.9 wt %, about 2 wt %, about 2.1 wt %, about 2.2 wt %, about 2.3 wt %, about 2.4 wt %, or about 2.5 wt % of the binder, based on the total weight of the fire-resistant panel.

In some embodiments, a weight ratio of the at least partially cured intumescent resin to a total amount of the blowing agent in the fire-resistant panel, whether the blowing agent is present only in the coating or is present in the coating and one or more other locations, e.g., the adhesive, the binder, and/or a secondary coating disposed on the fiber mat can be ≥1.5 ≥1.6, ≥1.7, ≥1.75, ≥1.77, ≥1.8, ≥1.83, ≥1.85, ≥1.87, or ≥1.9.

In some embodiments, the fire-resistant panel can include expandable graphite. In some embodiments, the expandable graphite can be present in the coating disposed on the second side of the fiber mat and/or in the adhesive used to secure fibers to one another. In other embodiments, the fire-resistant panel can include <10 wt %, <9 wt %, <8 wt %, <7 wt %, <6 wt %, <5 wt %, <4 wt %, <3 wt %, <2 wt %, <1 wt %, or <0.5 wt % of expandable graphite. In still other embodiments, the fire-resistant panel can be free of any intentionally added expandable graphite.

### Additional Blowing Agent(s)

In some embodiments, in addition to the adhesive including one or more intumescent resins, one or more acrylic adhesives, one or more bisphenol adhesives, one or more urea-formaldehyde resins, or a mixture thereof, the adhesive can also include one or more blowing agents. In some embodiments, in addition to or in lieu of the adhesive including one or more blowing agents, the binder used to secure the first side of the fiber mat to the substrate can include one or more blowing agents. In some embodiments, in addition to or in lieu of the adhesive and/or the binder including one or more blowing agents, a fiber mat that includes the secondary coating disposed thereon can include one or more blowing agents in the secondary coating. As such, in some embodiments, the blowing agent in the coating disposed on at least the second side of the fiber mat can be referred to as “the blowing agent in the coating”, the blowing agent in the adhesive, if present, can be referred to as another or second blowing agent, the blowing agent in the binder, if present, can be referred to as another or third blowing agent, and the blowing agent in the secondary coating of the fiber mat, if present, can be referred to as another or fourth blowing agent. The blowing agent that can be present in the adhesive (second blowing agent), the blowing agent that can be present in the binder (third blowing agent), and the blowing agent that can be present in the secondary coating of the fiber mat (fourth blowing agent) can be or can include, but is not limited to, one or more of the blowing agents described above. It should be understood that, if the fire-resistant overlay and/or the fire-resistant panel includes two blowing agents the blowing agent in the coating can be referred to as “the blowing agent’ and the additional blowing agent not present in the coating can be referred to as “the second blowing agent”. For example, if the fire-resistant overlay includes the blowing agent in the coating and another blowing agent in the secondary coating of the fiber mat, the blowing agent in the secondary coating can be referred to as “the second blowing agent” instead of “the third blowing agent.”

In some embodiments, the blowing agent in the coating, if present, the second blowing agent, if present, the third blowing agent, and, if present, the fourth blowing agent can have the same composition. In other embodiments, the blowing agent in the coating, if present, the second blowing agent, if present, the third blowing agent, and, if present, the fourth blowing agent can each have a different composition with respect to one another. In still other embodiments, when the blowing agent in the coating, the second blowing agent, the third blowing agent, and the fourth blowing agent are all present, any two or three of the blowing agent in the coating, the second blowing agent, the third blowing agent, and the fourth blowing agent can have the same composition and one or two of the blowing agent in the coating, the second blowing agent, the third blowing agent, and the fourth blowing agent can have a different composition. In some embodiments, the fire-resistant panel can include the blowing agent in the coating and at least one of the second blowing agent and the fourth blowing agent and can be free or substantially free from any intentionally added third blowing agent.

In some embodiments, when the fire-resistant panel includes the second blowing agent, a weight ratio of the blowing agent in the coating to the second blowing agent in the adhesive can be about 5:1, about 7:1, about 10:1, about 12:1, or about 15:1 to about 20:1, about 23:1, about 25:1, about 27:1, about 30:1, about 33:1, or about 35:1.

In some embodiments, when the fire-resistant panel includes the third blowing agent, a weight ratio of the blowing agent in the coating to the third blowing agent in the binder can be up to about 0.1:1, about 0.2:1, about 0.3:1, about 0.4:1, about 0.5:1, about 0.6:1, about 0.7:1, about 0.8:1, about 0.9:1, about 1:1, about 1.1:1, about 1.2:1, about 1.3:1, about 1.4:1, or about 1.5:1. In some embodiments, when the fire-resistant panel includes the third blowing agent, a weight ratio of the blowing agent in the coating to the third blowing agent in the binder can be ≤1.5:1, ≤1.4:1, ≤1.3:1, ≤1.2:1, ≤1.1:1, ≤1:1, ≤0.9:1, ≤0.8:1, ≤0.7:1, ≤0.6:1, ≤0.5:1, ≤0.4:1, ≤0.3:1, ≤0.2:1, or ≤0.1:1.

In some embodiments, when the fire-resistant panel includes the fourth blowing agent that can be present in the secondary coating of the fiber mat, a weight ratio of the blowing agent in the coating to the fourth blowing agent can be up about 1.5:1, about 1.6:1, about 1.7:1, about 1.8:1, about 1.9:1, about 2:1, about 2.1:1, about 2.3:1, or about 2.5:1. In some embodiments, when the fire-resistant panel includes the fourth blowing agent, a weight ratio of the blowing agent in the coating to the fourth blowing agent can be ≤2.5:1, ≤2.3:1, ≤2.2:1, ≤2.1:1, ≤2:1, ≤1.9:1, or ≤1.8:1.

In some embodiments, when the fire-resistant panel includes the second blowing agent and the third blowing agent, a weight ratio of the blowing agent in the coating to the second blowing agent in the adhesive can be about 5:1, about 7:1, about 10:1, or about 12:1 to about 15:1, about 20:1, about 25:1, about 30:1, or about 35:1, and a weight ratio of the blowing agent in the coating to the third blowing agent in the binder can be up to about 1:1, about 1.1:1, about 1.2:1, about 1.3:1, about 1.4:1, or about 1.5:1. In some embodiments, when the fire-resistant panel includes the second blowing agent, the third blowing agent, and the fourth, a weight ratio of the blowing agent in the coating to the second blowing agent in the adhesive can be about 5:1, about 7:1, about 10:1, or about 12:1 to about 15:1, about 20:1, about 25:1, about 30:1, or about 35:1, a weight ratio of the blowing agent in the coating to the third blowing agent in the binder can be up to about 1:1, about 1.1:1, about 1.2:1, about 1.3:1, about 1.4:1, or about 1.5:1, and a weight ratio of the blowing agent in the coating to the fourth blowing agent can be up to about 2:1. In some embodiments, when the fire-resistant panel includes the second blowing agent and the fourth blowing agent, a weight ratio of the blowing agent in the coating to the second blowing agent in the adhesive can be about 5:1, about 7:1, about 10:1, or about 12:1 to about 15:1, about 20:1, about 25:1, about 30:1, or about 35:1, and a weight ratio of the blowing agent in the coating to the fourth blowing agent in the “coated” fiber mat can be up to about 1:1, about 1.1:1, about 1.2:1, about 1.3:1, about 1.4:1, or about 1.5:1.

In some embodiments, the fire-resistant overlay and/or the fire-resistant panel includes the blowing agent in the coating, the blowing agent in the adhesive used to secure the fibers to one another to make the fiber mat (second blowing agent), and the blowing agent (third blowing agent) in a secondary coating disposed on the fibers that were used to make the fiberglass mat, a weight ratio of the third blowing agent to the second blowing agent can be about 3:1, about 5:1, about 7:1, about 9:1, or about 11:1 to about 13:1, about 15:1, about 20:1, about 25:1, about 30:1 or greater. In some embodiments, the amount of the third blowing agent in the secondary coating can be greater than the amount of the second blowing agent in the adhesive.

In some embodiments, the fire-resistant panel can include about 1 wt %, about 1.5 wt %, about 2 wt %, about 2.5 wt %, about 3 wt %, about 3.5 wt %, or about 4 wt % to about 4.5 wt %, about 5 wt %, about 5.5 wt %, about 6 wt %, about 6.5 wt %, about 7 wt %, about 7.5 wt %, about 8 wt %, about 8.5 wt %, about 9 wt %, about 9.5 wt %, or about 10 wt % of a combined amount of the blowing agent in the coating, any second blowing agent in the adhesive, any third blowing agent in the binder, and any fourth blowing agent present in the secondary coating of the fiber mat, based on a total weight of the fire-resistant panel.

### Substrates

The substrate can be or can include any substrate for which it is desirable to reduce the flammability thereof. In some embodiments, the substrate can be or can include, but is not limited to, oriented strand board (“OSB”), plywood (e.g., hardwood plywood and/or softwood plywood), structural fiberboard, diagonal tongue and groove solid lumber boards, foam board sheathing, glass faced gypsum panels, structural insulated sheathing (SIPS), structural composite lumber, glue-laminated lumber (Glulam), and other wood, non-wood products, and wood/non-wood products. Structural composite lumber can include, but is not limited to, laminated veneer lumber (LVL), parallel strand lumber (PSL), laminated strand lumber (LSL), and oriented strand lumber (OSL). As such, in some embodiments, the substrate can be a monolithic substrate such as the diagonal tongue and groove solid lumber boards or a composite substrate such as the oriented strand board that includes a plurality of lignocellulosic substrates bonded to one another with a glue.

As used herein, the term “glue”, like the terms “resin”, “adhesive”, and “binder”, refers to a composition that, prior to curing, is capable of bonding one or more substances together and is used to more readily identify which particular composition that is capable of bonding the one or more substances together is being discussed/described. In some embodiments, the glue can have the same composition or different composition as the resin, the adhesive, and/or the binder described above.

It should be understood that the glue that can be used to produce the substrates, e.g., oriented strand board and plywood, can also include one or more additives. Illustrative additives can be or can include, but are not limited to, waxes and/or other hydrophobic additives, water, filler material(s), extenders, surfactants, release agents, dyes, fire retardants, aldehyde scavengers, biocides, latexes, one or more adducts or polymers of styrene, at least one of maleic anhydride and maleic acid, and at least one of an acrylic acid and an acrylate, copolymers of one or more vinyl aromatic compounds and one or more unsaturated carboxylic acids, one or more unsaturated carboxylic anhydrides, or a combination of one or more unsaturated carboxylic acids and one or more unsaturated carboxylic anhydrides, or any combination or mixture thereof. Suitable additives can include those described in U.S. Pat. No. 10,889,716. In some embodiments, the glue that can be used to produce a composite substrate can be or can include, but is not limited to, one or more of the aldehyde-based resins described above. In some embodiments, suitable glues can include the resins, binders, and/or adhesives described in U.S. Patent Application Publication Nos.: 2013/0292864, 2013/0295319, 2016/0009967, 2016/0040006, and 2016/0263772. The substrates and processes for making the substrates are all well-known and do not need to be further described.

### Processes for Making Fire-Resistant Overlays

The fire-resistant overlays can be made by applying an uncured coating that includes the intumescent resin and the blowing agent to at least one of the first side and the second side of the fiber mat. In some embodiments, a mixture of the intumescent resin and the blowing agent can be applied to the fiber mat. In other embodiments, the intumescent resin can be applied to the fiber mat followed by the blowing agent. In still other embodiments, the blowing agent can be applied to the fiber mat followed by the intumescent resin. In still other embodiments, the intumescent resin and the blowing agent can be separately applied with respect to one another but at the same time as one another, e.g., via separate spray nozzles.

The fiber mat that includes the coating disposed thereon can be heated to a temperature of about 50° C. to about 175° C. for a time of about 5 minutes to about 180 minutes or about 15 minutes to about 90 minutes to produce the fire-resistant overlay. In some embodiments, the uncured coating that includes the mixture of the intumescent resin and blowing agent can be applied to at least one of the first side and the second side of the fiber mat at a loading level of about 40 wt %, about 45 wt %, about 50 wt %, or about 55 wt % to about 60 wt %, about 65 w %, about 70 wt %, or about 75 wt %, based on a combined weight of the fiber mat, the intumescent resin, and the blowing agent. In some embodiments, the uncured coating and fiber mat can be heated to a temperature of about 50° C., about 70° C., about 90° C., or about 110° C. to about 130° C., about 150° C., or about 175° C. for a time of about 15 minutes, about 30 minutes, or about 45 minutes to about 60 minutes, about 75 minutes, about 90 minutes, about 105 minutes, or about 120 minutes to produce a “cured” fiber mat that includes the at least partially cured intumescent resin.

### Processes for Making Fire-Resistant Panels

The fire-resistant panels can be made by securing the first side of the fiber mat to the substrate. For example, the binder can be applied to the first side of the fiber mat and/or the substrate and the fiber mat can be placed, located, or otherwise disposed onto the substrate. In some embodiments, the binder, which can be in a liquid form, e.g., aqueous-based, or a solid form, e.g., powder, can be applied to the first side of the fiber mat and/or the substrate using any suitable equipment/process, such as spray coating, roll coating, curtain coating, and/or dip and squeeze application. With the fiber mat disposed on the substrate the binder can be at least partially cured to secure the fiber mat to the substrate. In some embodiments, the fiber mat can include the coating disposed on the second side thereof when the fiber mat is disposed on the substrate. In other words, the first side of a fire-resistant overlay that includes the coating that includes the blowing agent and the at least partially cured intumescent resin disposed on the second side thereof can be disposed on and secured to the substrate to produce the fire-resistant panel. In other embodiments the coating can be disposed onto the second side of the fiber mat after the fiber mat has been secured to the substrate by at least partially curing the binder. In still other embodiments, the binder can be applied to the first side of the fiber mat and/or the substrate and the fiber mat can be placed, located, or otherwise disposed on the substrate, the uncured coating can be disposed on the second side of the fiber mat and the binder and the uncured coating can be at least partially cured to produce the fire-resistant substrate. In still other embodiments, the binder can be applied to the first side of the fiber mat and/or the substrate and the uncured coating can be disposed on the second side of the fiber mat and then the binder and the uncured coating can be at least partially cured to produce the fire-resistant substrate.

In some embodiments, the uncured coating that includes a mixture of the intumescent resin and blowing agent can be applied to at least the second side of the fiber mat at a loading level of about 40 wt %, about 45 wt %, about 50 wt %, or about 55 wt % to about 60 wt %, about 65 w %, about 70 wt %, or about 75 wt %, based on a combined weight of the fiber mat, the intumescent resin, and the blowing agent. In some embodiments, the uncured coating and fiber mat can be heated to a temperature of about 50° C., about 70° C., about 90° C., or about 110° C. to about 130° C., about 150° C., or about 175° C. for a time of about 15 minutes, about 30 minutes, or about 45 minutes to about 60 minutes, about 75 minutes, or about 90 minutes to produce a “cured” fiber mat that includes the at least partially cured intumescent resin.

In some embodiments, the binder can be applied to the substrate and/or the first side of the “cured” fiber mat at a loading level of about 0.5 wt %, about 0.7 wt %, about 0.9 wt %, or about 1.1 wt % to about 1.5 wt %, about 1.7 wt %, about 2 wt %, or about 2.5 wt %, based on a combined weight of the “cured” fiber mat, the substrate, and the binder. The binder can be allowed to at least partially cure to secure the “cured” fiber mat to the substrate to produce the fire-resistant panel. In some embodiments, the binder can be allowed to at least partially cure at room temperature. In other embodiments, the binder can be at least partially cured at an elevated temperature.

### EXAMPLES

In order to provide a better understanding of the foregoing discussion, the following non-limiting examples are offered. Although the examples can be directed to specific embodiments, they are not to be viewed as limiting the invention in any specific respect. All parts, proportions, and percentages are by weight unless otherwise indicated.

### Examples 1-11

In Examples 1-11, fire-resistant panels were made according to the following procedure. The substrate used to make all fire-resistant panels was oriented strand board having a nominal thickness of about 1.11 cm (about 7/16″). One of four fiberglass mats were selected from: (i) glass fibers that were bonded together with a urea-formaldehyde adhesive; (ii) glass fibers that were bonded together with a bisphenol epoxy adhesive, (iii) glass fibers that were bonded together with an acrylic adhesive, and (iv) glass fibers that were bonded together with a 90% urea-formaldehyde and 10% acrylic adhesive.

The intumescent resin used in all examples was a melamine-formaldehyde resin that had a molar ratio of formaldehyde to melamine of about 5.7:1 as determined via nuclear magnetic resonance (NMR) and a solids content of about 78 wt % to about 82 wt %. The blowing agent used in all of Examples 1-11 was triethyl ammonium phosphoric ester, which can also be referred to as, polyphosphoric acid, triethanolamine ester, that was acquired from the Lubrizol Corporation and had a CAS No. of 68131-71-5. The triethyl ammonium phosphoric ester served a dual purpose, i.e., it served as both the blowing agent and as a catalyst that promoted the at least partial curing of the melamine-formaldehyde resin to produce the coating on the fiberglass mat.

For Examples 1-11, a mixture of the intumescent resin and blowing agent was applied to the second side of the fiberglass mat at a loading level of about 50 wt % to about 70 wt %, based on the combined weight of the fiberglass mat, the intumescent resin, and the blowing agent. The mixture of the intumescent resin and the blowing agent was applied by dip coating such that the fiberglass mat was saturated with the mixture. The uncured coating and fiberglass mat was heated to a temperature of about 90° C. for a time of about 60 minutes to produce a “cured” fiberglass mat. The first side of the cured fiberglass mat was then adhered to the oriented strand board with a binder at a loading of about 0.7 wt % to about 0.78 wt %, based on the combined weight of the uncured fiberglass mat, the binder, and the oriented strand board. The weight of the uncured fiberglass mat included liquid present in the coating, i.e., liquid (water) present in the intumescent resin and liquid (water) present in the blowing agent. The adhesive was allowed to cure at room temperature.

As shown in Table 1 below, in addition to the triethyl ammonium phosphoric ester used in the coating that served as a blowing agent, the adhesive used to bond the glass fibers together to make the fiberglass mat and/or a coating applied to the fiberglass mat also included a blowing agent.

The fire-resistant panels in Examples 1-11 were all tested according to ASTM E2768-11(2018). As shown in Table 3, five of the fire-resistant panels satisfied ASTM E2768-11(2018), whereas six of the fire-resistant panels did not satisfy ASTM E2768-11(2018). Table 1 below shows some properties of the fiberglass mats used in the examples. In Table 1, the weight percent values of the blowing agent in the fiberglass mat adhesive and the blowing agent in the fiberglass mat secondary coating were calculated relative to the total wet panel weight and the glass mat adhesive weight percent values were calculated relative to the weight of the entire fiberglass mat.

TABLE 1

| | | | Blowing | | | |
|---|---|---|---|---|---|---|
| | | Blowing | Agent in | | | |
| | | Agent in | Fiberglass | | | |
| | Fiberglass | Fiberglass | Mat | | | |
| | Mat | Mat | Secondary | Glass | Glass Mat | Glass Mat |
| | Secondary | Adhesive | Coating | Fiber | Adhesive | Adhesive |
| Ex. | Coating | (wt %) | (wt %) | Diameter | Type | (wt %) |
| 1 | coated | 0.00 | 0.65-1.31 | 13 μm | Acrylic | 10 |
| 2 | uncoated | 0.12 | 0.00 | 10 μm in | Bisphenol | 3.6 |
| | | | | 600 μm | Epoxy | |
| | | | | bundles | Powder | |
| 3 | coated | 0.00 | 0.67-2.00 | 13 μm | Acrylic | 10 |
| 4 | uncoated | 0.12 | 0.00 | 10 μm in | Bisphenol | 3.6 |
| | | | | 600 μm | Epoxy | |
| | | | | bundles | Powder | |
| 5 | coated | 0.55 | 1.26-2.11 | 13.5 μm | 90% | 22 |
| | | | | | UF/10% | |
| | | | | | Acrylic | |
| 6 | uncoated | 0.12 | 0.00 | 10 μm in | Bisphenol | 3.6 |
| | | | | 600 μm | Epoxy | |
| | | | | bundles | Powder | |
| 7 | uncoated | 0.12 | 0.00 | 10 μm in | Bisphenol | 3.6 |
| | | | | 600 μm | Epoxy | |
| | | | | bundles | Powder | |
| 8 | coated | 0.55 | 1.26-2.11 | 13.5 μm | 90% | 22.0 |
| | | | | | UF/10% | |
| | | | | | Acrylic | |
| 9 | uncoated | 0.25 | 0.00 | 13.5 μm | UF | 20.0 |
| 10 | uncoated | 0.25 | 0.00 | 13.5 μm | UF | 20.0 |
| 11 | uncoated | 0.25 | 0.00 | 13.5 μm | UF | 20.0 |

As shown in Table 1, the fiberglass mats all had a blowing agent in the adhesive used to bond the glass fibers together and/or had a blowing agent in the coating that was on the fiberglass mat. The blowing agent in the adhesive used to bond the glass fibers together in Examples 2, 4, 6, and 7 was bisphenol epoxy. The blowing agent in the adhesive used to bond the glass fibers together in Examples 5 and 8 was urea-formaldehyde. The blowing agent in the adhesive used to bond the glass fibers together in Examples 9 and 10 was urea-formaldehyde. The blowing agent used in the coating that was the applied to the fiberglass mat by the manufacturer in Examples 1, 3, 5, and 8 was calcium carbonate. It should be clear that fiberglass mat “secondary coating” in the second column is the secondary coating that is separate and apart from the coating that includes the intumescent resin and the blowing agent that was also applied to the fiberglass mat.

Table 2 below shows the relative weight percent values of various components in the fire-resistant panels in Examples 1-11 and the type of binder that was used to secure the first side of the fiberglass mat to the oriented strand board. The weight percentages shown in Table 2 were calculated relative to the total “Wet” weight of the panel. The wet weight of the fire-resistant panel was calculated using kilograms of resin in solution (80% solution)+kilograms of blowing agent in solution (70% solution)+substrate weight (used an average weight for the substrate of about 23 kg for a typical oriented strand board having a width of about 1.22 m (about 4 ft), a length of about 2.44 m (about 8 ft) a thickness of about 1.11 cm (about 7/16″) (100% solids)+glass mat weight (100% solids)+binder weight (100% solids). For the weight percent values in Table 2 the following numbers were divided by the wet weight of the panel: (i) intumescent resin (wt %)=intumescent resin solids, (ii) blowing agent in coating (wt %)=blowing agent solids, (iii) glass mat (wt %)=glass mat basis weight, (iv) binder (wt %)=liquid binder (100% solids), and substrate (wt %)=a weight of about 23 kg for a standard oriented strand board having a width of about 1.22 m (about 4 ft), a length of about 2.44 m (about 8 ft) a thickness of about 1.11 cm (about 7/16″) (100% solids).

TABLE 2

| | | Blowing | | | | |
|---|---|---|---|---|---|---|
| | Intumescent | Agent in | Glass | | | |
| | Resin | Coating | Mat | Binder | Panel | |
| Ex. | (wt %) | (wt %) | (wt %) | (wt %) | (wt %) | Binder Type |
| 1 | 4.67 | 4.08 | 3.27 | 0.70 | 80.29 | Polyurethane |
| 2 | 4.15 | 3.63 | 3.33 | 0.71 | 81.91 | Polyurethane |
| 3 | 4.15 | 3.63 | 3.33 | 0.71 | 91.94 | Polyurethane |
| 4 | 3.96 | 3.47 | 3.36 | 0.72 | 82.55 | Polyurethane |
| 5 | 3.79 | 3.32 | 2.79 | 0.73 | 83.68 | Polyurethane |
| 6 | 3.77 | 3.30 | 3.38 | 0.72 | 83.17 | Polyurethane |
| 7 | 3.67 | 3.21 | 3.40 | 0.72 | 83.48 | EVA |
| 8 | 3.60 | 3.15 | 2.81 | 0.73 | 84.38 | Polyurethane |
| 9 | 2.83 | 2.48 | 1.24 | 0.77 | 88.44 | EVA |
| 10 | 2.29 | 2.00 | 1.26 | 0.78 | 90.24 | EVA |
| 11 | 2.29 | 2.00 | 1.26 | 0.78 | 90.24 | EVA |

As shown in Table 2 above, the amount of the intumescent resin ranged from about 2.29 wt % to about 4.67 wt %, the blowing agent in the coating that was applied to the fiberglass mat, whether the fiberglass mat was uncoated or had been coated with another composition as noted in Table 1 above, ranged from about 2.00 wt % to about 4.08 wt %. The amount of binder used to secure the first side of the fiberglass mat to the oriented strand board was held fairly constant at from about 0.70 wt % to about 0.78 wt %. The intumescent resin and blowing agent each also included water, which is not accounted for in Table 2. As such, Table 2 accounts for resin solids.

Table 3 below shows the resin solids, the weight ratio of the resin to the blowing agent, the total amount of blowing agent, and the ASTM E2768-11 (2018) test results.

TABLE 3

| | Resin | Resin:Blowing | Total | Max | Max | ASTM |
|---|---|---|---|---|---|---|
| | Solids | Agent weight | Blowing | Distance | Distance | E2768-11 |
| Ex. | (wt %) | ratio | Agent (wt %) | 10 min (m) | 30 min (m) | (2018) |
| 1 | 9.73 | 0.87-0.99 | 4.74-5.39 | 2.52 | 4.42 | Fail |
| 2 | 8.62 | 1.11 | 3.75 | 2.52 | 3.14 | Pass |
| 3 | 8.62 | 0.74-0.97 | 4.30-5.63 | 1.87 | 3.41 | Fail |
| 4 | 8.21 | 1.00 | 3.97 | 2.84 | 2.87 | Pass |
| 5 | 7.85 | 0.64-0.74 | 5.13-5.96 | 2.52 | 2.52 | Pass |
| 6 | 7.80 | 1.00 | 3.78 | 2.52 | 2.87 | Pass |
| 7 | 7.59 | 1.00 | 3.68 | 2.52 | 3.48 | Fail |
| 8 | 7.43 | 0.62-0.72 | 4.97-5.81 | 2.52 | 2.52 | Pass |
| 9 | 4.35 | 1.04 | 2.72 | 3.15 | n/a | Fail |
| 10 | 4.67 | 1.04 | 2.19 | 3.33 | n/a | Fail |
| 11 | 3.50 | 1.04 | 2.19 | 3.46 | n/a | Fail |

As shown in Table 3 the fire-resistant panels in Examples 2, 4-6, and 8 all passed the ASTM E2768-11 (2018) 30 minute Tunnel Test, whereas the fire-resistant panels in Examples 1, 3, 7, and 9-11 did not. To achieve a class A rating for E2768 the fire-resistant panel cannot have a maximum distance greater than 3.231 m (10.6 ft) after 30 minutes. This demonstrated that increasing the resin solids did not directly correlate to an improvement in performance, Ex 1 vs Ex 2, 4, 5, 6. To achieve a passing flame spread for E2768 the ratio of the resin solids to the blowing agent can be tailored.

### Examples 2-2

In Examples 12-28, fire-resistant panels were made according to the following procedure. The substrate used to make all fire-resistant panels was oriented strand board having a nominal thickness of about 1.11 cm (about 7/16″). One of four fiberglass mats were selected from: (i) glass fibers that were bonded together with a urea-formaldehyde adhesive; (ii) glass fibers that were bonded together with a bisphenol epoxy adhesive, (iii) glass fibers that were bonded together with an acrylic adhesive, and (iv) glass fibers that were bonded together with a 90% urea-formaldehyde and 10% acrylic adhesive.

For Examples 12-28, a mixture of the intumescent resin and the blowing agent was applied to the fiberglass mat by dip coating such that the fiberglass mat was saturated with the mixture and included the coating on both the first and second sides that were opposed to one another. The blowing agent used in all of Examples 12-28 was triethyl ammonium phosphoric ester, as purchased from the Lubrizol Corporation that had a CAS No. of 68131-71-5. The uncured coating and fiberglass mat was heated to a temperature of about 90° C. for a time of about 60 minutes to produce a fire-resistant overlay. The first side of the fire-resistant overlay was adhered to the oriented strand board with an adhesive at a loading of about 0.70 wt % to about 2.02 wt %, based on the weight of the fire-resistant panel. The adhesive was allowed to cure at room temperature.

The total weight of the fire-resistant overlay in Examples 12-28 was equal to the total solids weight of the fiberglass mat including the weight of any secondary coating if present+the solids weight of the intumescent resin in the fire-resistant overlay+the solids weight of the blowing agent in the fire-resistant overlay. The total weight of the fire-resistant panel in Examples 12-28 was equal to the uncured weight of the fire-resistant overlay+weight of the adhesive+weight of the substrate. As such, the weight percent values shown in Table 5 include water that was present in the intumescent resin and the blowing agent prior to heating the uncured coating and fiberglass mat to a temperature of about 90° C. for a time of about 60 minutes to produce the fire-resistant panel. For example, Example 14 that included 4.15 wt % of intumescent resin solids, 3.63 wt % of blowing agent in the coating, 3.33 wt % of the fiberglass, 0.71 wt % of the binder and 81.95 wt % of the panel (OSB) included 6.23 wt % of water (4.15%+3.63%+3.33%+0.71%+81.95%=93.77%; 100%−93.77%=6.23%) prior to heating the uncured coating and fiberglass mat to a temperature of about 90° C. for a time of about 60 minutes to produce the fire-resistant overlay.

Example 12 included 5.16 wt % of intumescent resin solids relative to the total wet weight of the fire-resistant panel, i.e., prior to heating the uncured coating and fiberglass mat to a temperature of about 90° C. for a time of about 60 minutes to produce the fire-resistant panel. The intumescent resin was a melamine formaldehyde-based resin that had a formaldehyde to melamine molar ratio of 1.5. The blowing agent in the coating had a solids content of 0.67% relative to the wet panel weight. The fiberglass mat was a chopped strand mat with a bisphenol epoxy powder binder. The fiberglass mat did not have an additional coating on top of it. The fiberglass mat had a basis weight of 300 g/m² and was 3.43 wt % relative to the total wet weight of the fire-resistant panel. The glass fibers that made up the mat were approximately 10 μm diameter fibers that were bundled in 600 μm diameter. In the overlay there was a blowing agent present in the coating on the mat and in the adhesive (bisphenol epoxy) that was used to secure the fibers in the fiberglass mat to one another. There was no secondary coating on the fiberglass mat. The coated fiberglass mat was adhered to an OSB panel with a liquid polyurethane binder. The loading of the liquid polyurethane binder was 2.02 wt % relative to the total wet weight of the fire-resistant panel.

Example 13 included 4.67 wt % of intumescent resin solids relative to the total wet weight of the fire-resistant panel, i.e., prior to heating the uncured coating and fiberglass mat to a temperature of about 90° C. for a time of about 60 minutes to produce the fire-resistant panel. The intumescent resin was a melamine formaldehyde-based resin that had a formaldehyde to melamine molar ratio of 4.9. The blowing agent in the coating had a solids content of 4.08% relative to the wet panel weight. The fiberglass mat was a continuous filament fiberglass mat that included an acrylic binder. The fiberglass mat had a secondary coating on it that included a mineral filler that contained calcium carbonate. The fiberglass mat had a basis weight of 300 g/m² and was 3.34 wt. % relative to the total wet weight of the fire-resistant panel. The glass fibers that made up the mat were approximately 13 μm diameter fibers. In the overlay there was a blowing agent present in the coating on the mat and in the adhesive (acrylic) that used to secure the fibers in the fiberglass mat to one another. The coated fiberglass mat was adhered to an OSB panel with a liquid polyurethane binder. The loading of the liquid polyurethane binder was 0.70 wt % relative to the total wet weight of the fire-resistant panel.

Example 14 included 4.15 wt % of intumescent resin solids relative to the total wet weight of the fire-resistant panel, i.e., prior to heating the uncured coating and fiberglass mat to a temperature of about 90° C. for a time of about 60 minutes to produce the fire-resistant panel. The intumescent resin was a melamine formaldehyde-based resin that had a formaldehyde to melamine molar ratio of 4.9. The blowing agent in the coating had a solids content of 3.63% relative to the wet panel weight. The fiberglass mat was a chopped strand mat with a bisphenol epoxy powder binder. The fiberglass mat did not have an additional coating on top of it. The fiberglass mat had a basis weight of 300 g/m² and was 3.33 wt % relative to the total wet weight of the fire-resistant panel. The glass fibers that made up the mat were approximately 10 μm diameter fibers that were bundled in 600 μm diameter. In the overlay there was a blowing agent present in the coating on the mat and in the adhesive (bisphenol epoxy) that used to secure the fibers in the fiberglass mat to one another. There was no secondary coating on the fiberglass mat. The coated fiberglass mat was adhered to an OSB panel with a liquid polyurethane binder. The loading of the liquid polyurethane binder was 0.71 wt % relative to the total wet weight of the fire-resistant panel.

Example 15 included 4.15 wt % of intumescent resin solids relative to the total wet weight of the fire-resistant panel, i.e., prior to heating the uncured coating and fiberglass mat to a temperature of about 90° C. for a time of about 60 minutes to produce the fire-resistant panel. The intumescent resin was a melamine formaldehyde-based resin that had a formaldehyde to melamine molar ratio of 4.9. The blowing agent in the coating had a solids content of 3.63% relative to the wet panel weight. The fiberglass mat was a continuous filament fiberglass mat that included an acrylic binder. The fiberglass mat had a secondary coating on it that included a mineral filler that contained calcium carbonate. The fiberglass mat had a basis weight of 300 g/m² and was 3.34 wt. % relative to the total wet weight of the fire-resistant panel. The glass fibers that made up the mat were approximately 13 μm diameter fibers. In the overlay there was a blowing agent present in the coating on the mat and in the adhesive (acrylic) that used to secure the fibers in the fiberglass mat to one another. The coated fiberglass mat was adhered to an OSB panel with a liquid polyurethane binder. The loading of the liquid polyurethane binder was 0.71 wt % relative to the total wet weight of the fire-resistant panel.

Example 16 included 3.96 wt % of intumescent resin solids relative to the total wet weight of the fire-resistant panel, i.e., prior to heating the uncured coating and fiberglass mat to a temperature of about 90° C. for a time of about 60 minutes to produce the fire-resistant panel. The resin was a melamine formaldehyde-based resin that had a formaldehyde to melamine molar ratio of 4.9. The blowing agent in the coating had a solids content of 3.47% relative to the wet panel weight. The fiberglass mat was a chopped strand mat with a bisphenol epoxy powder binder. The fiberglass mat did not have an additional coating on top of it. The fiberglass mat had a basis weight of 300 g/m² and was 3.36 wt % relative to the total weight of the fire-resistant panel. The glass fibers that made up the mat were approximately 10 μm diameter fibers that were bundled in 600 μm diameter. In the overlay there was blowing agent present in the coating on the mat and in the adhesive (bisphenol epoxy) that used to secure the fibers in the fiberglass mat to one another. There was no secondary coating on the fiberglass mat. The coated fiberglass mat was adhered to an OSB panel with a liquid polyurethane binder. The loading of the liquid polyurethane binder was 0.72 wt % relative to the total wet weight of the fire-resistant panel.

Example 17 included 3.77 wt % of intumescent resin solids relative to the total wet weight of the fire-resistant panel, i.e., prior to heating the uncured coating and fiberglass mat to a temperature of about 90° C. for a time of about 60 minutes to produce the fire-resistant panel. The intumescent resin was a melamine formaldehyde-based resin with a formaldehyde to melamine molar ratio of 4.9. The blowing agent in the coating had a solids content of 3.30% relative to the wet panel weight. The fiberglass mat was a chopped strand mat that had a bisphenol epoxy powder binder. The fiberglass mat did not have an additional coating on top of it. The fiberglass mat had a basis weight of 300 g/m² and was 3.38 wt % relative to the total weight of the fire-resistant panel. The glass fibers that made up the mat were approximately 10 μm diameter fibers that were bundled in 600 μm diameter. In the overlay there was a blowing agent present in the coating on the mat and in the fiberglass mat adhesive. There was no secondary coating on the fiberglass mat. The coated fiberglass mat was adhered to an OSB panel with a liquid polyurethane binder. The loading of the liquid polyurethane binder was 0.72 wt % relative to the total wet weight of the fire-resistant panel.

Example 18 included 3.76 wt % of intumescent resin solids relative to the total wet weight of the fire-resistant panel, i.e., prior to heating the uncured coating and fiberglass mat to a temperature of about 90° C. for a time of about 60 minutes to produce the fire-resistant panel. The intumescent resin was a melamine formaldehyde-based resin that had a formaldehyde to melamine molar ratio of 4.9. The blowing agent in the coating had a solids content of 3.29% relative to the total wet weight of the fire-resistant panel, i.e., prior to heating the uncured coating and fiberglass mat to a temperature of about 90° C. for a time of about 60 minutes to produce the fire-resistant panel. The fiberglass mat was a continuous filament fiberglass mat that included 90 wt % urea-formaldehyde and 10 wt % acrylic binder. The fiberglass mat had a secondary coating on it that included a mineral filler that contained calcium carbonate and kaolin. The fiberglass mat included about 10 wt % to a bout 70 wt % of the calcium carbonate and about 0 wt % to about 50 wt % of the kaolin, based on the dry weight of the fiberglass mat. The fiberglass mat had a basis weight of 327 g/m² and was 3.69 wt % relative to the total weight of the fire-resistant panel. The glass fibers that made up the mat were approximately 13.5 μm diameter fibers. In the overlay there was a blowing agent present in the coating on the mat, in the adhesive, and in the secondary coating that was on the fiberglass mat. The coated fiberglass mat was adhered to an OSB panel with a liquid polyurethane binder. The loading of the liquid polyurethane binder was 0.72 wt % relative to the total wet weight of the fire-resistant panel. In the overlay there was a blowing agent present in the coating on the mat, in the binder, and in the secondary coating on the fiberglass mat.

Example 19 included 3.67 wt % of intumescent resin solids relative to the total wet weight of the fire-resistant panel, i.e., prior to heating the uncured coating and fiberglass mat to a temperature of about 90° C. for a time of about 60 minutes to produce the fire-resistant panel. The intumescent resin was a melamine formaldehyde-based resin with a formaldehyde to melamine molar ratio of 4.9. The blowing agent in the coating had a solids content of 3.21% relative to the wet panel weight. The fiberglass mat was a chopped strand mat that had a bisphenol epoxy powder binder. The fiberglass mat did not have an additional coating on top of it. The fiberglass mat had a basis weight of 300 g/m² and was 3.39 wt % relative to the total weight of the fire-resistant panel. The glass fibers that made up the mat were approximately 10 μm diameter fibers that were bundled in 600 μm diameter. In the overlay there was a blowing agent present in the coating on the mat and in the fiberglass mat adhesive. There was no secondary coating on the fiberglass mat. The coated fiberglass mat was adhered to an OSB panel with a liquid polyurethane binder. The loading of the liquid polyurethane binder was 0.72 wt % relative to the total wet weight of the fire-resistant panel.

Example 20 included 3.56 wt % of intumescent resin solids relative to the total wet weight of the fire-resistant panel, i.e., prior to heating the uncured coating and fiberglass mat to a temperature of about 90° C. for a time of about 60 minutes to produce the fire-resistant panel. The intumescent resin was a melamine formaldehyde-based resin that had a formaldehyde to melamine molar ratio of 4.9. The blowing agent in the coating had a solids content of 3.12% relative to the wet panel weight. The fiberglass mat was a continuous filament fiberglass mat that included a 90% urea formaldehyde and 10% acrylic binder. The fiberglass mat had a secondary coating on it that included a mineral filler that contained calcium carbonate and kaolin. The fiberglass mat included about 10 wt % to about 35 wt % of the calcium carbonate and about 0 wt % to about 50 wt % of the kaolin, based on the weight of the dry fiberglass mat. The fiberglass mat had a basis weight of 327 g/m² and was 3.71 wt % relative to the total weight of the fire-resistant panel. The glass fibers that made up the mat were approximately 13.5 μm diameter fibers. In the overlay there was a blowing agent present in the coating on the mat, in the fiberglass mat adhesive, and in the secondary coating that was on the fiberglass mat. The coated fiberglass mat was adhered to an OSB panel with a liquid polyurethane binder. The loading of the liquid polyurethane binder was 0.72 wt % relative to the total wet weight of the fire-resistant panel.

Example 21 included 3.48 wt % of intumescent resin solids relative to the total wet weight of the fire-resistant panel, i.e., prior to heating the uncured coating and fiberglass mat to a temperature of about 90° C. for a time of about 60 minutes to produce the fire-resistant panel. The resin was a melamine formaldehyde-based resin that had a formaldehyde to melamine molar ratio of 1.55. The blowing agent in the coating had a solids content of 4.07% relative to the wet panel weight. The fiberglass mat was a chopped strand mat that included a bisphenol epoxy powder binder. The fiberglass mat did not include a secondary coating. The fiberglass mat had a basis weight of 300 g/m² and was 3.39 wt % relative to the total weight of the fire-resistant panel. The glass fibers that made up the mat were approximately 10 μm diameter fibers that were bundled in 600 μm diameter. In the overlay there was blowing agent present in the coating on the mat and in the fiberglass mat binder. There was no secondary coating on the fiberglass mat. The coated fiberglass mat was adhered to an OSB panel with a liquid polyurethane binder. The loading of the liquid polyurethane binder was 1.90 wt % relative to the total wet weight of the fire-resistant panel.

Example 22 included 3.35 wt % of intumescent resin solids relative to the total wet weight of the fire-resistant panel, i.e., prior to heating the uncured coating and fiberglass mat to a temperature of about 90° C. for a time of about 60 minutes to produce the fire-resistant panel. The resin was a melamine formaldehyde-based resin that had a formaldehyde to melamine molar ratio of 1.55. The blowing agent in the coating had a solids content of 3.91% relative to the wet panel weight. The fiberglass mat was a chopped strand mat that included a bisphenol epoxy powder binder. The fiberglass mat did not include a secondary coating. The fiberglass mat had a basis weight of 300 g/m² and was 3.24 wt % relative to the total weight of the fire-resistant panel. The glass fibers that made up the mat were approximately 10 μm diameter fibers that were bundled in 600 μm diameter. In the overlay there was blowing agent present in the coating on the mat and in the fiberglass mat binder. There was no secondary coating on the fiberglass mat. The coated fiberglass mat was adhered to an OSB panel with a liquid polyurethane binder. The loading of the liquid polyurethane binder was 1.91 wt % relative to the total wet weight of the fire-resistant panel.

Example 23 included 3.21 wt % of intumescent resin solids relative to the total wet weight of the fire-resistant panel, i.e., prior to heating the uncured coating and fiberglass mat to a temperature of about 90° C. for a time of about 60 minutes to produce the fire-resistant panel. The resin was a melamine formaldehyde-based resin that had a formaldehyde to melamine molar ratio of 1.55. The blowing agent in the coating had a solids content of 3.75% relative to the wet panel weight. The fiberglass mat was a chopped strand mat that included a bisphenol epoxy powder binder. The fiberglass mat did not include a secondary coating. The fiberglass mat had a basis weight of 300 g/m² and was 3.27 wt % relative to the total weight of the fire-resistant panel. The glass fibers that made up the mat were approximately 10 μm diameter fibers that were bundled in 600 μm diameter. In the overlay there was blowing agent present in the coating on the mat and in the fiberglass mat binder. There was no secondary coating on the fiberglass mat. The coated fiberglass mat was adhered to an OSB panel with a liquid polyurethane binder. The loading of the liquid polyurethane binder was 1.93 wt % relative to the total wet weight of the fire-resistant panel.

Example 24 included 3.08 wt % of intumescent resin solids relative to the total wet weight of the fire-resistant panel, i.e., prior to heating the uncured coating and fiberglass mat to a temperature of about 90° C. for a time of about 60 minutes to produce the fire-resistant panel. The resin was a melamine formaldehyde-based resin that had a formaldehyde to melamine molar ratio of 1.55. The blowing agent in the coating had a solids content of 3.59% relative to the wet panel weight. The fiberglass mat was a chopped strand mat that included a bisphenol epoxy powder binder. The fiberglass mat did not include a secondary coating. The fiberglass mat had a basis weight of 300 g/m² and was 3.29 wt % relative to the total weight of the fire-resistant panel. The glass fibers that made up the mat were approximately 10 μm diameter fibers that were bundled in 600 μm diameter. In the overlay there was blowing agent present in the coating on the mat and in the fiberglass mat binder. There was no secondary coating on the fiberglass mat. The coated fiberglass mat was adhered to an OSB panel with a liquid polyurethane binder. The loading of the liquid polyurethane binder was 1.91 wt % relative to the total wet weight of the fire-resistant panel.

Example 25 included 2.35 wt % of intumescent resin solids relative to the total wet weight of the fire-resistant panel, i.e., prior to heating the uncured coating and fiberglass mat to a temperature of about 90° C. for a time of about 60 minutes to produce the fire-resistant panel. The resin was a melamine formaldehyde-based resin that had a formaldehyde to melamine molar ratio of 4.9. The blowing agent in the coating had a solids content of 2.06 wt % relative to the wet panel weight. The fiberglass mat was a chopped strand mat that included a bisphenol epoxy powder binder. The fiberglass mat did not include a secondary coating. The fiberglass mat had a basis weight of 300 g/m² and was 3.58 wt % relative to the total weight of the fire-resistant panel. The glass fibers that made up the mat were approximately 10 μm diameter fibers that were bundled in 600 μm diameter. In the overlay there was blowing agent present in the coating on the mat and in the fiberglass mat binder. There was no secondary coating on the fiberglass mat. The coated fiberglass mat was adhered to an OSB panel with a liquid polyurethane binder. The loading of the liquid polyurethane binder was 0.35 wt % relative to the total wet weight of the fire-resistant panel.

Example 26 included 2.12 wt % of intumescent resin solids relative to the total wet weight of the fire-resistant panel, i.e., prior to heating the uncured coating and fiberglass mat to a temperature of about 90° C. for a time of about 60 minutes to produce the fire-resistant panel. The resin was a melamine formaldehyde-based resin that had a formaldehyde to melamine molar ratio of 4.9. The blowing agent in the coating had a solids content of 2.48 wt % relative to the wet panel weight. The fiberglass mat was a chopped strand mat that included a bisphenol epoxy powder binder. The fiberglass mat did not include a secondary coating. The fiberglass mat had a basis weight of 103 g/m² and was 1.24 wt % relative to the total weight of the fire-resistant panel. The glass fibers that made up the mat were approximately 13.5 μm diameter. In the overlay there was blowing agent present in the coating on the mat and in the fiberglass mat binder. There was no secondary coating on the fiberglass mat. The coated fiberglass mat was adhered to an OSB panel with a liquid polyurethane binder. The loading of the liquid polyurethane binder was 0.77 wt % relative to the total wet weight of the fire-resistant panel.

Example 27 included 2.00 wt % of intumescent resin solids relative to the total wet weight of the fire-resistant panel, i.e., prior to heating the uncured coating and fiberglass mat to a temperature of about 90° C. for a time of about 60 minutes to produce the fire-resistant panel. The resin was a melamine formaldehyde-based resin that had a formaldehyde to melamine molar ratio of 4.9. The blowing agent in the coating had a solids content of 2.00 wt % relative to the wet panel weight. The fiberglass mat was a chopped strand mat that included a bisphenol epoxy powder binder. The fiberglass mat did not include a secondary coating. The fiberglass mat had a basis weight of 103 g/m² and was 1.26 wt % relative to the total weight of the fire-resistant panel. The glass fibers that made up the mat were approximately 13.5 μm diameter. In the overlay there was blowing agent present in the coating on the mat and in the fiberglass mat binder. There was no secondary coating on the fiberglass mat. The coated fiberglass mat was adhered to an OSB panel with a liquid polyurethane binder. The loading of the liquid polyurethane binder was 0.78 wt % relative to the total wet weight of the fire-resistant panel.

Example 28 included 1.71 wt % of intumescent resin solids relative to the total wet weight of the fire-resistant panel, i.e., prior to heating the uncured coating and fiberglass mat to a temperature of about 90° C. for a time of about 60 minutes to produce the fire-resistant panel. The resin was a melamine formaldehyde-based resin that had a formaldehyde to melamine molar ratio of 4.9. The blowing agent in the coating had a solids content of 2.00 wt % relative to the wet panel weight. The fiberglass mat was a chopped strand mat that included a bisphenol epoxy powder binder. The fiberglass mat did not include a secondary coating. The fiberglass mat had a basis weight of 103 g/m² and was 1.26 wt % relative to the total weight of the fire-resistant panel. The glass fibers that made up the mat were approximately 13.5 μm diameter. In the overlay there was blowing agent present in the coating on the mat and in the fiberglass mat binder. There was no secondary coating on the fiberglass mat. The coated fiberglass mat was adhered to an OSB panel with a liquid polyurethane binder. The loading of the liquid polyurethane binder was 0.78 wt % relative to the total wet weight of the fire-resistant panel.

In Table 4, the amount of the blowing agent in the fiberglass mat adhesive (wt %) and the amount of the blowing agent in the fiberglass mat coating (wt %) were calculated relative to the total weight of the fire-resistant overlay, while the amount of the glass mat adhesive (wt %) was calculated based on the weight of the fiberglass mat alone. If the fiberglass mat included a secondary coating, the weight of the secondary coating was included. As explained above, the total weight of the fire-resistant overlay was equal to the total weight of the fiberglass mat including the weight of any secondary coating if present+the solids weight of the intumescent resin in the fire-resistant overlay+the solids weight of the blowing agent in the fire-resistant overlay.

TABLE 4

| | | | Blowing | | | |
|---|---|---|---|---|---|---|
| | | Blowing | Agent in | | | |
| | | Agent in | Fiberglass | | | |
| | | Fiberglass | Mat | | | |
| | Fiberglass | Mat | Secondary | Glass | | Glass Mat |
| | Mat | Adhesive | Coating | Fiber | Glass Mat | Adhesive |
| Ex. | Coating | (wt %) | (wt %) | Diameter | Adhesive Type | (wt %) |
| 12 | Uncoated | 3.64% | 0.00% | 10 μm in | Bisphenol | 3.64% |
| | | | | 600 μm | Epoxy Powder | |
| | | | | bundles | | |
| 13 | Coated | 0.75% | 30.79% | 13 μm | Acrylic | 10.00% |
| 14 | Uncoated | 3.64% | 0.00% | 10 μm in | Bisphenol | 3.64% |
| | | | | 600 μm | Epoxy Powder | |
| | | | | bundles | | |
| 15 | Coated | 0.75% | 30.79% | 13 μm | Acrylic | 10.00% |
| 16 | Uncoated | 3.64% | 0.00% | 10 μm in | Bisphenol | 3.64% |
| | | | | 600 μm | Epoxy Powder | |
| | | | | bundles | | |
| 17 | Uncoated | 3.64% | 0.00% | 10 μm in | Bisphenol | 3.64% |
| | | | | 600 μm | Epoxy Powder | |
| | | | | bundles | | |
| 18 | Coated | 2.31% | 30.79% | 13.5 μm | 90% Urea | 22.00% |
| | | | | | Formaldehyde/ | |
| | | | | | 10% Acrylic | |
| 19 | Uncoated | 3.64% | 0.00% | 10 μm in | Bisphenol | 3.64% |
| | | | | 600 μm | Epoxy Powder | |
| | | | | bundles | | |
| 20 | Coated | 2.31% | 30.79% | 13.5 μm | 90% Urea | 22.00% |
| | | | | | Formaldehyde/ | |
| | | | | | 10% Acrylic | |
| 21 | Uncoated | 3.64% | 0.00% | 10 μm in | Bisphenol | 3.64% |
| | | | | 600 μm | Epoxy Powder | |
| | | | | bundles | | |
| 22 | Uncoated | 3.64% | 0.00% | 10 μm in | Bisphenol | 3.64% |
| | | | | 600 μm | Epoxy Powder | |
| | | | | bundles | | |
| 23 | Uncoated | 3.64% | 0.00% | 10 μm in | Bisphenol | 3.64% |
| | | | | 600 μm | Epoxy Powder | |
| | | | | bundles | | |
| 24 | Uncoated | 3.64% | 0.00% | 10 μm in | Bisphenol | 3.64% |
| | | | | 600 μm | Epoxy Powder | |
| | | | | bundles | | |
| 25 | Uncoated | 3.64% | 0.00% | 10 μm in | Bisphenol | 3.64% |
| | | | | 600 μm | Epoxy Powder | |
| | | | | bundles | | |
| 26 | Uncoated | 20.00% | 0.00% | 13.5 μm | Urea | 20.00% |
| | | | | | Formaldehyde | |
| 27 | Uncoated | 20.00% | 0.00% | 13.5 μm | Urea | 20.00% |
| | | | | | Formaldehyde | |
| 28 | Uncoated | 20.00% | 0.00% | 13.5 μm | Urea | 20.00% |
| | | | | | Formaldehyde | |

The weight percent values shown in Table 5 were calculated based on the total weight of the fire-resistant panel minus water that was present in the intumescent resin and the blowing agent.

TABLE 5

| | Intumescent | Blowing | | | | |
|---|---|---|---|---|---|---|
| | Resin | Agent in | Glass | | | |
| | Solids | Coating | Mat | Binder | Panel | Binder |
| Ex. | (wt %) | (wt %) | (wt %) | (wt %) | (wt %) | Type |
| 12 | 5.16% | 0.67% | 3.43% | 2.02% | 84.32% | Polyurethane |
| 13 | 4.67% | 4.08% | 3.27% | 0.70% | 80.28% | Polyurethane |
| 14 | 4.15% | 3.63% | 3.33% | 0.71% | 81.95% | Polyurethane |
| 15 | 4.15% | 3.63% | 3.34% | 0.71% | 81.94% | Polyurethane |
| 16 | 3.96% | 3.47% | 3.36% | 0.72% | 82.55% | Polyurethane |
| 17 | 3.77% | 3.30% | 3.38% | 0.72% | 83.17% | Polyurethane |
| 18 | 3.76% | 3.29% | 3.69% | 0.72% | 82.91% | Polyurethane |
| 19 | 3.67% | 3.21% | 3.39% | 0.72% | 83.48% | Polyurethane |
| 20 | 3.56% | 3.12% | 3.71% | 0.72% | 83.53% | Polyurethane |
| 21 | 3.48% | 4.07% | 3.22% | 1.90% | 79.20% | Polyurethane |
| 22 | 3.35% | 3.91% | 3.24% | 1.91% | 79.77% | Polyurethane |
| 23 | 3.21% | 3.75% | 3.27% | 1.93% | 80.34% | Polyurethane |
| 24 | 3.08% | 3.59% | 3.29% | 1.94% | 80.93% | Polyurethane |
| 25 | 2.35% | 2.06% | 3.58% | 0.35% | 88.13% | Polyurethane |
| 26 | 2.12% | 2.48% | 1.24% | 0.77% | 88.44% | EVA |
| 27 | 2.00% | 2.00% | 1.26% | 0.78% | 90.24% | EVA |
| 28 | 1.71% | 2.00% | 1.26% | 0.78% | 90.24% | EVA |

Table 6 below shows the intumescent resin solids (wt %), the weight ratio of the intumescent resin to the blowing agent, the total amount of the blowing agent, and the ASTM E2768-11(2018) test results.

TABLE 6

| | Resin | Resin:Blowing | Total | Max | Max | ASTM |
|---|---|---|---|---|---|---|
| | Solids | Agent weight | Blowing | Distance | Distance | E2768-11 |
| Ex. | (wt %) | ratio | Agent (wt %) | 10 min (m) | 30 min (ft) | (2018) |
| 12 | 5.16% | 6.53 | 0.79% | 2.97 | 5.06 | Fail |
| 13 | 4.67% | 0.66-0.81 | 5.74-7.05% | 2.52 | 4.42 | Fail |
| 14 | 4.15% | 1.11 | 3.75% | 2.52 | 3.14 | Pass |
| 15 | 4.15% | 0.63-0.78 | 5.30-6.64% | 1.87 | 3.41 | Fail |
| 16 | 4.10% | 1.14 | 3.59% | 2.84 | 2.87 | Pass |
| 17 | 3.96% | 1.16 | 3.42% | 2.52 | 2.87 | Pass |
| 18 | 3.77% | 0.57-0.69 | 5.5-6.6% | 2.52 | 2.52 | Pass |
| 19 | 3.76% | 1.13 | 3.33% | 2.52 | 3.48 | Fail |
| 20 | 3.72% | 0.58-0.70 | 5.34-6.45% | 2.52 | 2.52 | Pass |
| 21 | 3.67% | 0.88 | 4.19% | 0.20 | 3.87 | Fail |
| 22 | 3.56% | 0.88 | 4.03% | 1.80 | 3.14 | Pass |
| 23 | 3.48% | 0.9 | 3.87% | 2.06 | 3.35 | Fail |
| 24 | 3.35% | 0.83 | 3.71% | 1.89 | 3.60 | Fail |
| 25 | 3.21% | 1.47 | 2.18% | 4.48 | 5.09 | Fail |
| 26 | 3.08% | 0.83 | 2.73% | 1.78 | N/A | Fail |
| 27 | 2.35% | 1.04 | 2.25% | 2.08 | N/A | Fail |
| 28 | 2.12% | 0.94 | 2.25% | 1.96 | N/A | Fail |

As shown in Table 6 the fire-resistant panels in Examples 14, 16-18, 20, and 22 all passed the ASTM E2768-11 (2018) 30 minute Tunnel Test, whereas the fire-resistant panels in Examples 12, 13, 15, 19, 21, and 23-28 did not.

### Examples 29-44

In Examples 29-44, fire-resistant overlays were made the same way and had the same composition as the fire-resistant overlays made in Examples 12-27, respectively. The fire-resistant overlays in Examples 29-44 were tested according to the modified ASTM D6413-99, where the test was modified by using a run time of 5 minutes instead of 12 seconds. The fire-resistant overlays in Examples 29-44 corresponded to the fire-resistant overlays used in Examples 12-27, i.e., the fire-resistant overlays were made the same way and had the same composition, respectively. As such, the fire-resistant overlays, i.e., Examples 31, 33-35, 37 and 39, corresponded to the fire-resistant overlays used in the successful full-scale Examples of the fire-resistant panels that are shown in Table 6 above, i.e., Examples 14, 16-18, 20, and 22, respectively. When designing an overlay to be successful in passing the ASTM E2768-11 test when adhered to a substrate, e.g., oriented strand board, the characteristics obtained via the modified ASTM D6413-99 test on the fire-resistant overlay can be used as a target for overlay properties to scale up to the full-size ASTM E2768-11 (2018) test that evaluates the fire-resistant panel.

As shown in Table 7, when a side of the fire-resistant overlay that included the coating disposed thereon was subjected to the modified ASTM D6413-99 test, all examples produced a char. The char density (g/cm³), char travel (cm), and char height (cm) properties were all measured after subjecting the fire-resistant overlay to the modified ASTM D6413-99 test. The expansion ratio was the ratio of the combined thickness of the fiberglass mat and char after subjecting the fire-resistant overlay to the modified ASTM D6413-99 test divided by the original thickness of the fire-resistant overlay The density was measured according to ASTM C914-09(2022). The char travel length was measured with a caliper. The char height was measured with a digital caliper that had a sensitivity to the ten thousandths of a millimeter. The expansion ratio was the ratio of the combined thickness of the fiberglass mat and char after subjecting the fire-resistant overlay to the modified ASTM D6413-99 test divided by the original thickness of the fiberglass mat and the coating disposed thereon. The original thickness of the fire-resistant overlay was measured using with a Model MTG-DX2—material thickness gauge available from Rex Gauge Company, Inc. After the fire-resistant overlay was subjected to the modified ASTM D6413-99 test, the thickness of the char was measured using a digital caliper that had a sensitivity to the ten thousandths of a millimeter.

The weight percent values of the intumescent resin and the blowing agent in Table 7 are based on the combined weight of the intumescent resin solids, the blowing agent, and the fiberglass mat. As such, the weight percent values shown in Table 7 were based on the dry weight of the fire-resistant overly, i.e., the solids weight of the fiberglass mat, the solids weight of the intumescent resin, and the solids weight of the blowing agent.

TABLE 7

| | | Blowing | | | | |
|---|---|---|---|---|---|---|
| | | Agent in | | Char | | |
| | Intumescent | Coating | Char | Travel | Char | |
| | Resin Solids | Solids | Density | length | Height | Expansion |
| Example | (wt %) | (wt %) | (g/cm³) | (cm) | (cm) | Ratio |
| 29 | 55.74% | 7.23% | 0.21 | 8.33 | 1.22 | 9.45 |
| 30 | 38.81% | 33.96% | 0.07 | 13.11 | 4.34 | 15.99 |
| 31 | 37.35% | 32.68% | 0.12 | 9.09 | 1.83 | 17.07 |
| 32 | 37.31% | 32.65% | 0.10 | 10.85 | 3.18 | 15.63 |
| 33 | 36.74% | 32.15% | 0.13 | 9.37 | 1.68 | 14.98 |
| 34 | 36.08% | 31.57% | 0.19 | 10.01 | 1.32 | 10.83 |
| 35 | 35.02% | 30.64% | 0.07 | 9.80 | 2.41 | 14.93 |
| 36 | 35.73% | 31.26% | 0.18 | 8.13 | 1.35 | 12.68 |
| 37 | 34.28% | 30.00% | 0.06 | 9.80 | 1.96 | 11.21 |
| 38 | 32.36% | 37.75% | 0.15 | 8.28 | 2.16 | 19.13 |
| 39 | 31.90% | 37.22% | 0.14 | 9.25 | 1.98 | 16.86 |
| 40 | 31.42% | 36.65% | 0.25 | 7.67 | 1.91 | 19.07 |
| 41 | 30.90% | 36.05% | 0.15 | 9.58 | 1.78 | 18.02 |
| 42 | 29.42% | 25.74% | 0.17 | 8.33 | 0.99 | 10.7 |
| 43 | 36.36% | 42.42% | 0.37 | 9.50 | 1.22 | 13.08 |
| 44 | 38.00% | 38.00% | 0.36 | 9.91 | 1.22 | 13.53 |

As shown in Table 7, Examples 31, 33-35, 37 and 39 that were subjected to the modified ASTM D6413-99 test all had a char that was produced that had a density of about 0.05 g/cm³ to about 0.2 g/cm³, a char travel length of about 8.8 cm to about 10.2, a char height of about 1.25 cm to about 2.5 cm, and an expansion ratio of about 10 to about 17.5. In contrast, none of the fire-resistant overlays in Examples 29, 30, 32, 36, 38, and 40-44 had a char that was produced by subjecting the fire-resistant overlay to the modified ASTM D6413-99 that had a density of about 0.05 g/cm³ to about 0.2 g/cm³, a char travel length of about 8.8 cm to about 10.2, a char height of about 1.25 cm to about 2.5 cm, and an expansion ratio of about 10 to about 17.5.

The present disclosure further relates to any one or more of the following numbered embodiments:

1. A fire-resistant panel, comprising: a substrate; a fiber mat comprising a plurality of fibers secured to one another and having a first side and a second side opposed to one another, wherein the first side of the fiber mat is secured to the substrate; and a coating disposed on the second side of the fiber mat, wherein the coating comprises a blowing agent and an at least partially cured intumescent resin, and wherein the fire-resistant panel satisfies the Standard Test Method for Extended Duration Surface Burning Characteristics of Building Materials (30 min Tunnel Test) according to ASTM E2768-11(2018).

2. A process for making a fire-resistant panel, comprising: securing a first side of a fiber mat to a substrate, wherein the fiber mat comprises a plurality of fibers secured to one another, wherein a coating is disposed on a second side of the fiber mat that opposes the first side, wherein the coating comprises a blowing agent and an at least partially cured intumescent resin, and wherein the fire-resistant panel satisfies the Standard Test Method for Extended Duration Surface Burning Characteristics of Building Materials (30 min Tunnel Test) according to ASTM E2768-11(2018).

3. The fire-resistant panel or process according to paragraph 1 or 2, wherein the fire-resistant panel further satisfies the Standard Test Methods for Fire Tests of Building Construction and Materials according to ASTM E119-20.

4. The fire-resistant panel or process according to any of paragraphs 1 to 3, wherein, prior to curing, the intumescent resin in the coating comprises an aldehyde-based resin, a polyacrylate, a polyurethane, an epoxy resin having phenolic cross-linkers, a polystyrene, a halogenated polymer, or a mixture thereof.

5. The fire-resistant panel or process according to any of paragraphs 1 to 4, wherein, prior to curing, the intumescent resin in the coating comprises a melamine-formaldehyde resin, a urea-formaldehyde resin, a melamine-urea-formaldehyde resin, or a mixture thereof.

6. The fire-resistant panel or process according to any of paragraphs 1 to 5, wherein the blowing agent in the coating comprises phosphoric acid, ammonium phosphate, triethyl phosphate, triethyl ammonium phosphoric ester, triethanolamine, maleic acid, urea, calcium carbonate, urea formaldehyde, bisphenol, or a mixture thereof.

7. The fire-resistant panel or process according to any of paragraphs 1 to 6, wherein the blowing agent in the coating comprises phosphoric acid, ammonium phosphate, triethyl phosphate, triethyl ammonium phosphoric ester, or a mixture thereof.

8. The fire-resistant panel or process according to any of paragraphs 1 to 7, wherein, prior to curing the intumescent resin, the coating comprises about 50 wt % to about 99 wt % of the intumescent resin and about 1 wt % to about 50 wt % of the blowing agent, based on a combined weight of the intumescent resin and the blowing agent.

9. The fire-resistant panel or process according to any of paragraphs 1 to 8, wherein the coating comprises about 52 wt % to about 92 wt % of the at least partially cured intumescent resin and about 8 wt % to about 48 wt % of the blowing agent, based on a combined weight of the at least partially cured intumescent resin and the blowing agent.

10. The fire-resistant panel or process according to any of paragraphs 1 to 9, wherein the coating is free of or contains expandable graphite in an amount of <10 wt %, based on a total weight of the coating.

11. The fire-resistant panel or process according to any of paragraphs 1 to 10, wherein the fibers in the fiber mat are secured to one another with an at least partially cured adhesive.

12. The fire-resistant panel or process according to any of paragraph 11, wherein, prior to curing, the adhesive is in the form of a liquid, a powder, or a mixture thereof.

13. The fire-resistant panel or process according to paragraph 11 or 12, wherein the adhesive, prior to curing, comprises an aldehyde-based resin, a polyacrylate, a polyurethane, an epoxy resin having phenolic cross-linkers, a polystyrene, a halogenated polymer, or a mixture thereof.

14. The fire-resistant panel or process according to any of paragraphs 11 to 13, wherein, prior to curing, a composition of the adhesive is different than a composition of the intumescent resin.

15. The fire-resistant panel or process according to any of paragraphs 11 to 13, wherein, prior to curing, a composition of the adhesive is the same as a composition of the intumescent resin.

16. The fire-resistant panel or process according to any of paragraphs 11 to 13, wherein, prior to curing, a composition of the adhesive is the same as a composition of the coating.

17. The fire-resistant panel or process according to any of paragraphs 11 to 16, wherein the adhesive comprises a second blowing agent.

18. The fire-resistant panel or process according to paragraph 17, wherein a composition of the second blowing agent is different than a composition of the blowing agent in the intumescent resin.

19. The fire-resistant panel or process according to paragraph 17, wherein a composition of the second blowing agent is the same as a composition of the blowing agent in the intumescent resin.

20. The fire-resistant panel or process according to any of paragraphs 17 to 19, wherein the second blowing agent comprises triethanolamine, maleic acid, urea, calcium carbonate, a urea-formaldehyde resin, bisphenol, an acrylic or a mixture thereof.

21. The fire-resistant panel or process according to any of paragraphs 17 to 20, wherein a weight ratio of the blowing agent in the coating to the second blowing agent in the adhesive is about 5:1 to about 35:1.

22. The fire-resistant panel or process according to any of paragraphs 1 to 21, wherein the fiber mat is secured to the substrate with an at least partially cured binder.

23. The fire-resistant panel or process according to paragraph 22, wherein, prior to curing, a composition of the binder is different than a composition of the intumescent resin and the adhesive.

24. The fire-resistant panel or process according to paragraph 22, wherein, prior to curing, a composition of the binder is the same as a composition of the intumescent resin and different than a composition of the adhesive.

25. The fire-resistant panel or process according to paragraph 22, wherein, prior to curing, a composition of the binder is the same as a composition of the intumescent resin and as a composition of the adhesive.

26. The fire-resistant panel or process according to paragraph 22, wherein, prior to curing, a composition of the binder is different than a composition of the intumescent binder and the same as a composition of the adhesive.

27. The fire-resistant panel or process according to paragraph 22, wherein, prior to curing, the binder comprises a polyurethane, an ethylene-vinyl acetate, bisphenol, an acrylic, or a mixture thereof.

28. The fire-resistant panel or process according to any of paragraphs 22 to 27, wherein the binder comprises a third blowing agent.

29. The fire-resistant panel or process according to paragraph 28, wherein a composition of the third blowing agent is different than a composition of the blowing agent in the coating and, if present, different than a composition of the second blowing agent in the adhesive.

30. The fire-resistant panel or process according to paragraph 28, wherein a composition of the third blowing agent is the same as a composition of the blowing agent in the coating and, if present, is different as the composition of the second blowing agent in the adhesive.

31. The fire-resistant panel or process according to paragraph 28, wherein a composition of the third blowing agent is the same as a composition of the blowing agent in the coating and, if present, is the same as the composition of the second blowing agent in the adhesive.

32. The fire-resistant panel or process according to paragraph 28, wherein a composition of the third blowing agent is different than a composition of the blowing agent in the coating and, if present, the same as the composition of the second blowing agent in the adhesive.

33. The fire-resistant panel or process according to any of paragraphs 28 to 32, wherein the third blowing agent comprises triethanolamine, maleic acid, urea, calcium carbonate, a urea-formaldehyde resin, bisphenol, an acrylic, or a mixture thereof.

34. The fire-resistant panel or process according to any of paragraphs 28 to 33, wherein a weight ratio of the blowing agent in the coating to the third blowing agent in the binder is up to 1.5:1.

35. The fire-resistant panel or process according to any of paragraphs 17 to 34, wherein a weight ratio of the blowing agent in the coating to the second blowing agent in the adhesive is about 5:1 to about 35:1, and wherein a weight ratio of the blowing agent in the coating to the third blowing agent in the binder is up to about 1.5:1.

36. The fire-resistant panel or process according to any of paragraphs 17 to 35, wherein a weight ratio of the second blowing agent in the adhesive to the third blowing agent in the binder is up to about 1:2.

37. The fire-resistant panel or process according to any of paragraphs 28 to 36, wherein the fire-resistant panel comprises about 3 wt % to about 6 wt % of a combined amount of the blowing agent in the coating, any second blowing agent in the adhesive, and any third blowing agent in the binder, based on a total weight of the fire-resistant panel.

38. The fire-resistant panel or process according to any of paragraphs 1 to 37, wherein the fire-resistant panel comprises about 3 wt % to about 5 wt % of the at least partially cured intumescent resin, based on a total weight of the fire-resistant panel.

39. The fire-resistant panel or process according to any of paragraphs 1 to 38, wherein the fire-resistant panel comprises about 3 wt % to about 4 wt % of the blowing agent, based on a total weight of the fire-resistant panel.

40. The fire-resistant panel or process according to any of paragraphs 1 to 39, wherein the fire-resistant panel comprises about 2 wt % to about 4 wt % of the plurality of fibers, based on a total weight of the fire-resistant panel.

41. The fire-resistant panel or process according to any of paragraphs 1 to 40, wherein the fire-resistant panel comprises about 80 wt % to about 85 wt % of the substrate, based on a total weight of the fire-resistant panel.

42. The fire-resistant panel or process according to any of paragraphs 1 to 41, wherein the fire-resistant panel comprises about 0.5 wt % to about 0.75 wt % of the adhesive, based on a total weight of the fire-resistant panel.

43. The fire-resistant panel or process according to any of paragraphs 1 to 42, wherein the fire-resistant panel comprises about 0.5 wt % to about 2 wt % of the binder, based on a total weight of the fire-resistant panel.

44. The fire-resistant panel or process according to any of paragraphs 27 to 43, wherein a weight ratio of the at least partially cured intumescent resin to a combined amount of the blowing agent in the coating, any second blowing agent in the adhesive, and any third blowing agent in the binder is ≥1.75.

45. The fire-resistant panel or process according to any of paragraphs 1 to 44, wherein the substrate comprises oriented-strand board, plywood, structural fiberboard, diagonal tongue and grove solid lumber boards, foam board, gypsum boards, or structural insulated sheathing.

46. The fire-resistant panel or process according to any of paragraphs 1 to 45, wherein the fiber mat is a non-woven, single layer, fiber mat.

47. The fire-resistant panel or process according to any of paragraphs 1 to 46, wherein the fiber mat has an average thickness of about 0.75 mm to about 1 mm.

48. The fire-resistant panel or process according to any of paragraphs 1 to 47, wherein the fiber mat has basis weight of about 0.02 g/cm² to about 2.5 g/cm².

49. The fire-resistant panel or process according to any of paragraphs 1 to 48, wherein the plurality of fibers is uncoated.

50. The fire-resistant panel or process according to any of paragraphs 1 to 49, wherein the plurality of fibers is coated with an inorganic filler material in addition to the adhesive.

51. The fire-resistant panel or process according to paragraph 50, wherein the inorganic filler material comprises calcium carbonate.

52. The fire-resistant panel or process according to any of paragraphs 1 to 51, wherein the plurality of fibers has an average length of about 1 cm to about 4 cm.

53. The fire-resistant panel or process according to any of paragraphs 1 to 52, wherein the plurality of fibers has an average diameter of about 10 μm to about 14 μm.

54. The fire-resistant panel or process according to any of paragraphs 1 to 53, wherein the plurality of fibers has an average length to diameter ratio of about 10:1 to about 40:1.

55. The fire-resistant panel or process according to any of paragraphs 1 to 54, wherein, prior to curing, the intumescent resin comprises a melamine-formaldehyde resin having a molar ratio of formaldehyde to melamine of about 3:1 to about 6:1.

56. The fire-resistant panel or process according to any of paragraphs 1 to 55, wherein the blowing agent in the coating is also a catalyst that facilitates the at least partial curing of the intumescent resin to produce the coating.

57. The fire-resistant panel or process according to any of paragraphs 1 to 56, wherein the fibers in the plurality of fibers comprise mineral fibers, ceramic fibers, metal fibers, metal coated mineral fibers, aramid fibers, polyimide fibers, polyacronitrile (PAN) fibers, carbon fibers, or any mixture thereof.

58. The fire-resistant panel or process according to any of paragraphs 1 to 57, wherein the fibers in the plurality of fibers comprise glass fibers.

59. A process for making a fire-resistant overlay, comprising: applying a coating to at least one side of a fiber mat comprising a plurality of fibers, wherein the coating comprises an intumescent resin and a blowing agent; and at least partially curing the intumescent resin to produce the fire-resistant overlay, wherein, when the at least one side of the fiber mat comprising the coating disposed thereon is subjected to a modified standard test method for flame resistance of textiles, ASTM D6413-99, where the test is modified by using a run time of 5 minutes instead of 12 seconds, a char is produced that has a density of about 0.05 g/cm³ to about 0.2 g/cm³, a length of about 8.8 cm to about 10.2, a height of about 1.25 cm to about 2.5 cm, and an expansion ratio of about 10 to about 17.5.

60. The process of paragraph 59, wherein the intumescent resin is at least partially cured by heating the coating applied to the at least one side of the fiber mat.

61. The process of paragraph 60, wherein the coating applied to the at least one side of the fiber mat is heated to a temperature of about 50° C. to about 175° C. for a time of about 15 minutes to about 90 minutes to produce the fire-resistant overlay.

62. The process of any of paragraph 59 to 61, wherein the intumescent resin comprises an aldehyde-based resin, a polyacrylate, a polyurethane, an epoxy resin having phenolic cross-linkers, a polystyrene, a halogenated polymer, or a mixture thereof.

63. The process of any of paragraphs 59 to 62, wherein the blowing agent comprises phosphoric acid, ammonium phosphate, triethyl phosphate, triethyl ammonium phosphoric ester, triethanolamine, maleic acid, urea, calcium carbonate, urea formaldehyde, bisphenol, or a mixture thereof.

64. The process of any of paragraphs 59 to 63, wherein at least partially curing the intumescent resin forms a coating.

65. The process of paragraph 64, wherein the coating comprises about 40 wt % to about 60 wt % of the at least partially cured intumescent resin and about 40 wt % to about 60 wt % of the blowing agent, based on a combined solids weight of the at least partially cured intumescent resin and the blowing agent.

66. The process of paragraph 64 or 65, wherein the coating is free of or contains expandable graphite in an amount of <10 wt %, based on a total solids weight of the coating.

67. The process of any of paragraphs 59 to 66, wherein the fibers in the fiber mat are secured to one another with an at least partially cured adhesive.

68. The process of paragraph 67, wherein the adhesive, prior to curing, comprises an aldehyde-based resin, a polyacrylate, a polyurethane, an epoxy resin having phenolic cross-linkers, a polystyrene, a halogenated polymer, or a mixture thereof.

69. The process of paragraph 67 or 68, wherein the adhesive comprises a second blowing agent, and wherein the second blowing agent comprises triethanolamine, maleic acid, urea, calcium carbonate, a urea-formaldehyde resin, bisphenol, an acrylic or a mixture thereof.

70. The process of paragraph 69, wherein a weight ratio of the blowing agent in the coating to the second blowing agent in the adhesive is about 5:1 to about 35:1.

71. The process of paragraph 69 or 70, wherein a weight ratio of the at least partially cured intumescent resin to a combined amount of the blowing agent in the coating and the second blowing agent in the adhesive is ≥1.75.

72. The process of any of paragraphs 59 to 71, wherein the intumescent resin comprises a melamine-formaldehyde resin having a molar ratio of formaldehyde to melamine of about 1.3:1 to about 6:1.

73. The process of any of paragraphs 59 to 72, wherein the fibers in the plurality of fibers comprise glass fibers.

74. The process of any of paragraphs 59 to 73, wherein: the intumescent resin comprises a melamine-formaldehyde resin, the fibers in the fiber mat are secured to one another with an at least partially cured adhesive, and, prior to curing, the adhesive comprises a bisphenol epoxy powder, a mixture of about 90% of urea formaldehyde resin and about 10% of acrylic, or a mixture thereof.

75. A fire-resistant overlay, comprising: a fiber mat comprising a plurality of fibers secured to one another and having a first side and a second side opposed to one another, wherein the fiber mat has a thickness extending from a surface of the first side to a surface of the second side of about 0.3 mm to about 1.5 mm; and a coating disposed on at least one of the first side and the second side of the fiber mat, wherein the coating comprises a blowing agent and an at least partially cured intumescent resin, and wherein, when a side of the fiber mat comprising the coating disposed thereon is subjected to a modified standard test method for flame resistance of textiles, ASTM D6413-99, wherein the test is modified by using a run time of 5 minutes instead of 12 seconds, a char is produced that has a density of about 0.05 g/cm3 to about 0.2 g/cm3, a length of about 8.8 cm to about 10.2, a height of about 1.25 cm to about 2.5 cm, and an expansion ratio of about 10 to about 17.5, wherein the height is measured from a surface of the char to the side of the fire-resistant overlay that is opposite the surface of the char.

76. A fire-resistant panel, comprising: a substrate; a fiber mat comprising a plurality of fibers secured to one another and having a first side and a second side opposed to one another, wherein the first side of the fiber mat is secured to the substrate; and a coating disposed on the second side of the fiber mat, wherein the coating comprises a blowing agent and an at least partially cured intumescent resin, and wherein the fire-resistant panel satisfies a Standard Test Method for Extended Duration Surface Burning Characteristics of Building Materials (30 min Tunnel Test) according to ASTM E2768-11(2018).

77. A fire-resistant panel, comprising: a substrate; a fiber mat comprising a plurality of fibers secured to one another and having a first side and a second side opposed to one another, wherein the first side of the fiber mat is secured to the substrate; and a coating disposed on the second side of the fiber mat, wherein the coating comprises a blowing agent and an at least partially cured intumescent resin, and wherein the fire-resistant panel satisfies a Standard Test Method for Fire Tests of Building Construction and Materials ASTM E119-07(2021).

78. A process for making a fire-resistant panel, comprising: securing a first side of a fiber mat to a substrate, wherein the fiber mat comprises a plurality of fibers secured to one another, wherein a coating is disposed on a second side of the fiber mat that opposes the first side, wherein the coating comprises a blowing agent and an at least partially cured intumescent resin, and wherein the fire-resistant panel satisfies at least one of: a Standard Test Method for Extended Duration Surface Burning Characteristics of Building Materials (30 min Tunnel Test) according to ASTM E2768-11(2018) and a Standard Test Method for Fire Tests of Building Construction and Materials according to ASTM E119-20.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

1. A fire-resistant overlay, comprising:
a fiber mat comprising a plurality of fibers secured to one another and having a first side and a second side opposed to one another, wherein the fiber mat has a thickness extending from a surface of the first side to a surface of the second side; and
a coating disposed on at least one of the first side and the second side of the fiber mat, wherein the coating comprises a blowing agent and an at least partially cured intumescent resin, and wherein, when a side of the fiber mat comprising the coating disposed thereon is subjected to a modified standard test method for flame resistance of textiles, ASTM D6413-99, where the test is modified by using a run time of 5 minutes instead of 12 seconds, a char is produced that has a density of about 0.05 g/cm³ to about 0.2 g/cm3, a length of about 8.8 cm to about 10.2, a height of about 1.25 cm to about 2.5 cm, and an expansion ratio of about 10 to about 17.5.

2. The fire-resistant overlay of claim 1, wherein, prior to curing, the intumescent resin in the coating comprises an aldehyde-based resin, a polyacrylate, a polyurethane, an epoxy resin having phenolic cross-linkers, a polystyrene, a halogenated polymer, or a mixture thereof.

3. The fire-resistant overlay of claim 1, wherein the blowing agent comprises phosphoric acid, ammonium phosphate, triethyl phosphate, triethyl ammonium phosphoric ester, triethanolamine, maleic acid, urea, calcium carbonate, urea formaldehyde, bisphenol, or a mixture thereof.

4. The fire-resistant overlay of claim 1, wherein the coating comprises about 40 wt % to about 60 wt % of the at least partially cured intumescent resin and about 40 wt % to about 60 wt % of the blowing agent, based on a combined solids weight of the at least partially cured intumescent resin and the blowing agent.

5. The fire-resistant overlay of claim 1, wherein the coating is free of or contains expandable graphite in an amount of <10 wt %, based on a total solids weight of the coating.

6. The fire-resistant overlay of claim 1, wherein the fibers in the fiber mat are secured to one another with an at least partially cured adhesive.

7. The fire-resistant overlay of claim 6, wherein the adhesive, prior to curing, comprises an aldehyde-based resin, a polyacrylate, a polyurethane, an epoxy resin having phenolic cross-linkers, a polystyrene, a halogenated polymer, or a mixture thereof.

8. The fire-resistant overlay of claim 6, wherein the adhesive comprises a second blowing agent, and wherein the second blowing agent comprises triethanolamine, maleic acid, urea, calcium carbonate, a urea-formaldehyde resin, bisphenol, an acrylic or a mixture thereof.

9. The fire-resistant overlay of claim 8, wherein a weight ratio of the blowing agent in the coating to the second blowing agent in the adhesive is about 5:1 to about 35:1.

10. The fire-resistant overlay of claim 8, wherein a weight ratio of the at least partially cured intumescent resin to a combined amount of the blowing agent in the coating and the second blowing agent in the adhesive is ≥1.75.

11. The fire-resistant overlay of claim 10, wherein, prior to curing, the intumescent resin comprises a melamine-formaldehyde resin having a molar ratio of formaldehyde to melamine of about 1.3:1 to about 6:1.

12. The fire-resistant overlay of claim 11, wherein the fibers in the plurality of fibers comprise glass fibers, and wherein the thickness extending from the surface of the first side to the surface of the second side is about 0.3 mm to about 1.5 mm.

13. The fire-resistant overlay of claim 12, wherein:
prior to curing, the intumescent resin in the coating comprises a melamine-formaldehyde resin,
the fibers in the fiber mat are secured to one another with an at least partially cured adhesive, and
prior to curing, the adhesive comprises a bisphenol epoxy powder, a mixture of about 90% of urea formaldehyde resin and about 10% of acrylic, or a mixture thereof.

14. A fire-resistant panel, comprising:
a substrate;
a fiber mat comprising a plurality of fibers secured to one another and having a first side and a second side opposed to one another, wherein the first side of the fiber mat is secured to the substrate; and
a coating disposed on the second side of the fiber mat, wherein the coating comprises a blowing agent and an at least partially cured intumescent resin, and wherein the fire-resistant panel satisfies at least one of: a Standard Test Method for Extended Duration Surface Burning Characteristics of Building Materials (30 min Tunnel Test) according to ASTM E2768-11(2018) and a Standard Test Method for Fire Tests of Building Construction and Materials according to ASTM E119-20.

15. The fire-resistant panel of claim 14, wherein the fire-resistant panel satisfies the Standard Test Method for Extended Duration Surface Burning Characteristics of Building Materials (30 min Tunnel Test) according to ASTM E2768-11(2018).

16. The fire-resistant panel of claim 14, wherein the fire-resistant panel satisfies the Standard Test Method for Fire Tests of Building Construction and Materials according to ASTM E119-20.

17. The fire-resistant panel of claim 14, wherein:
prior to curing, the intumescent resin in the coating comprises an aldehyde-based resin, a polyacrylate, a polyurethane, an epoxy resin having phenolic cross-linkers, a polystyrene, a halogenated polymer, or a mixture thereof, and
the blowing agent comprises phosphoric acid, ammonium phosphate, triethyl phosphate, triethyl ammonium phosphoric ester, triethanolamine, maleic acid, urea, calcium carbonate, urea formaldehyde, bisphenol, or a mixture thereof.

18. The fire-resistant panel of claim 14, wherein the coating comprises about 40 wt % to about 60 wt % of the at least partially cured intumescent resin and about 40 wt % to about 60 wt % of the blowing agent, based on a combined weight of the at least partially cured intumescent resin and the blowing agent.

19. The fire-resistant panel of claim 14, wherein the fibers in the fiber mat are secured to one another with an at least partially cured adhesive, and wherein, prior to curing, the adhesive comprises an aldehyde-based resin, a polyacrylate, a polyurethane, an epoxy resin having phenolic cross-linkers, a polystyrene, a halogenated polymer, or a mixture thereof.

20. The fire-resistant panel of claim 14, wherein the fiber mat is secured to the substrate with an at least partially cured binder.
